(19) United States
(12) Patent Application Publication
(10) Pub. No.: US 2024/0166099 A1
(43) Pub. Date: May 23, 2024

(54) CHILD SAFETY SEAT

(71) Applicant: Wonderland Switzerland AG, Steinhausen (CH)

(72) Inventors: Kyle S. Mason, Lititz, PA (US); Clyde S. Harmes, V, Mohnton, PA (US); Leif Malm, Elverson, PA (US)

(21) Appl. No.: 18/548,736

(22) PCT Filed: Mar. 11, 2022
(86) PCT No.: PCT/EP2022/056383

§ 371 Date: Sep. 1, 2023

Related U.S. Application Data
(60) Provisional application No. 63/159,727, filed on Mar. 11, 2021.
(60) Provisional application No. 63/221,502, filed on Jul. 14, 2021.
(60) Provisional application No. 63/221,503, filed on Jul. 14, 2021.

(51) Int. Cl. B60N 2/28

(52) U.S. Cl. CPC B60N 2/2812; B60N 2/2806; B60N 2/2821; B60N 2/2866; B60N 2/2875

(57) ABSTRACT

A child safety seat for a vehicle includes a main seat, a harness, and a belt-positioning seat. The main seat includes a seatback, a seat bottom attached to the seatback, and a pair of belt guides. The seat bottom has a first seating surface defining a receiving space between the pair of belt guides. The harness includes first and second straps, and a crotch buckle. The belt-positioning seat includes a seat body and at least one belt-positioning guide. The seat body has a second seating surface, and a bottom surface. The at least one belt-positioning guide protrudes upward from the second seating surface. The seat body is removably coupled to the seat bottom in the receiving space such that, when the seat body is positioned in the receiving space, the crotch buckle is positioned above the second seating surface to removably fasten to the first and second shoulder straps.

### PRIORITY CLAIM AND CROSS-REFERENCE

The current application claims priority to provisional application 63/159,727 filed Mar. 11, 2021, provisional application 63/221,502 filed Jul. 14, 2021, and provisional application 63/221,503 filed Jul. 14, 2021, the entire contents of which are incorporated herein by reference in their entirety.

### BACKGROUND

Many booster seat products currently available on the market are sold as a booster seat with a removable backrest that is convertible to a booster seat having no backrest as the child grows. The legal age requirement for a child to be seated on a booster seat has increased over the years, and current booster seats are rated for 10-year old children. At the age of 10, the child can be transported by different caregivers. For example, a parent may drop the child off at school, and another caregiver may pick up the child after school. Existing booster seats are usually large and bulky, which makes it difficult for the child to carry the booster seat or requires the caregivers to purchase multiple booster seats.

Further, many child booster seats and convertible seats currently available on the market are sold with object holders such as cup holders and/or snack holders. The object holders commonly extend beyond a width of the seating surface, resulting in the overall width of the seat being greater than a width of the seating surface.

### SUMMARY

In accordance with one embodiment, a child safety seat for a vehicle includes a main seat, a harness, and a belt-positioning seat. The main seat includes a seatback, a seat bottom attached to the seatback, and a pair of belt guides. The seat bottom has a first seating surface that defines a receiving space between the pair of belt guides. The harness includes a first strap, a second strap, and a crotch buckle. The belt-positioning seat includes a seat body and at least one belt-positioning guide. The seat body has a second seating surface, and a bottom surface that is configured to be placed on a vehicle seat. The at least one belt-positioning guide protrudes upward from the second seating surface. The seat body is configured to be removably coupled to the seat bottom in the receiving space such that, when the seat body is positioned in the receiving space, the crotch buckle is positioned above the second seating surface to removably fasten to the first and second shoulder straps.

In accordance with another embodiment, a child safety seat includes a base, a main seat, a lock, and a belt-positioning seat. The main seat is supported by the base and includes a seat bottom and a seatback. The seat bottom includes a pair of belt guides that define a receiving space therebetween. The seatback is attached to the seat bottom and is configured to move relative to the base such that the seatback moves between an upright configuration and a reclined configuration. The lock is configured to selectively fix the main seat relative to the base in the upright and reclined configurations. The belt-positioning seat is configured to be received in the receiving space to removably couple the belt-positioning seat to the main seat. The belt-positioning seat includes a seat body and at least one belt guide. The seat body has an upper seating surface, and a bottom surface adapted to be placed on a vehicle seat. The at least one belt guide protruding upward from the seat body.

In accordance with another embodiment, a child safety seat includes a recline base, a main seat, a harness, and a belt-positioning seat. The main seat is supported by the recline base. The main seat includes a seat bottom and a seatback. The seat bottom includes a seating surface configured to support a child thereon. The seatback is attached to the seat bottom and includes a surface configured to support a back of a child. The harness includes a first strap, a second strap, and a crotch buckle. The belt-positioning seat includes a second seating surface and at least one belt-positioning guide. The belt-positioning seat configured to be removably coupled to the seat bottom. The child safety seat is selectively configurable in: 1) a rear-facing configuration in which the main seat is moved relative to the recline base from an upright position to a reclined position, 2) a forward-facing, harnessed booster configuration in which the main seat is moved relative to the recline base from the reclined position to an inclined position, 3) a forward-facing, harnessless booster configuration in which at least a portion of the harness is removed or positioned beneath a cushion of the main seat, 4) a forward-facing, backless booster configuration in which the seatback is removed from the seat bottom, and 5) a belt-positioning booster configuration in which the belt-positioning seat is removed from the main seat.

In accordance with another embodiment, a belt-positioning seat is configured to be removably attached to a main seat of a child safety seat. The belt-positioning seat includes a seat body and at least one belt guide. The seat body has a seating surface and a bottom surface that are opposite one another so as to define a plate-like shape. The bottom surface is configured to be placed on the main seat when coupled to the main seat. The seat body includes an opening therethrough that is configured to receive at least a portion of a crotch strap of a harness of the main seat therethrough. The at least one belt guide is attached to the seat body. The at least one belt guide has a deployed position in which the at least one belt guide protrudes upward from the seat body, and a storage position in which the at least one belt guide is stowed in a storage cavity provided in the seat body.

In accordance with another embodiment, a belt-positioning seat is configured to be removably attached to a main seat of a child safety seat. The belt-positioning seat includes a seat body, at least one belt guide, at least one movable latch, and an actuator. The seat body has a seating surface and a bottom surface that are opposite one another to define a plate-like shape. The bottom surface is configured to be placed on the main seat when the belt-positioning seat is coupled thereto. The at least one belt guide is attached to the seat body and protrudes upward from the seat body. The at least one movable latch is configured to be transitioned between a latched position so as to fasten the belt-positioning seat to the main seat when received in a receiving space of the main seat, and an unlatched position so as to unfasten the belt-positioning seat from the main seat. The actuator is configured to be engaged by a user to transition the latch between the latched and unlatched positions.

In accordance with another embodiment, a child safety seat includes a seatback, a seat bottom, and at least one object holder. The seat bottom extends from the seatback along a first direction and has a seating surface. The at least one object holder is coupled to the seat bottom such that the at least one object holder is rotatable relative to the seat bottom between an extended position and a stowed position. The at least one object holder extends further out from the seat bottom along a direction, perpendicular to the first direction, when the object holder is in the extended position than when the object holder is in the stowed position.

In accordance with another embodiment, a child safety seat includes a seatback, a seat bottom, at least one object holder, and a tether. The seat bottom extends from the seatback and has a seating surface. The at least one tether attaches the at least one object holder to the seat bottom.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. It is emphasized that, in accordance with standard practice in the industry various features may not be drawn to scale and are used for illustration purposes only. In fact, the dimensions of the various features in the drawings may be arbitrarily increased or decreased for clarity of discussion.

FIG. 1 is a front perspective view of a child safety seat according to an embodiment;

FIG. 2 is a side view of the child safety seat of FIG. 1 in a forward-facing high-back booster configuration;

FIG. 3A is a side view of the child safety seat of FIG. 1 in a rear-facing, reclined configuration;

FIG. 3B is a side view of a portion of the child safety seat of FIG. 1 in a forward-facing backless booster configuration;

FIG. 4 is a front perspective view of a seatback of the child safety seat of FIG. 1;

FIG. 5 is a front perspective view of a main seat of the child safety seat of FIG. 1, including the seatback of FIG. 4 and a seat bottom;

FIG. 6A is a perspective view of the seat bottom of the child safety seat of FIG. 1 attached to a base;

FIG. 6B is another perspective view of the seat bottom of the child safety seat of FIG. 1 attached to a recline base;

FIG. 7 is a rear perspective view of a portion of the main seat of the child safety seat of FIG. 1 including the seatback of FIG. 4 and the seat bottom of FIGS. 6A and 6B;

FIG. 8 is a perspective view of the recline base of the child safety seat of FIG. 1;

FIG. 9 is a perspective view of a recline lock according to one example of the recline base of the child safety seat of FIG. 1;

FIG. 10 is a perspective view of a portion of the child safety seat of FIG. 1 having a recline base according to some embodiments and with a seating surface removed to show an alternative recline lock according to an embodiment;

FIG. 11 is a perspective view of the recline base of FIG. 10;

FIG. 12 is a perspective view of the recline lock of FIG. 10;

FIG. 13 is a perspective view of a child safety seat having a recline base according to some embodiments, with the child safety seat in an inclined configuration;

FIG. 14 is a perspective view of the child safety seat of FIG. 13, with the child safety seat in a reclined configuration;

FIG. 15 is a top perspective view of a removable belt-positioning seat of the child safety seat of FIG. 1, with a pair of belt guides in a storage position;

FIG. 16 is a top perspective view of the removable belt-positioning seat of the child safety seat of FIG. 15, with the pair of belt guides in a deployed position;

FIG. 17 is a bottom perspective view of the removable belt-positioning seat of the child safety seat of FIG. 15, with the pair of belt guides in the stowed position;

FIG. 18 is a bottom perspective view of the removable belt-positioning seat of the child safety seat of FIG. 15, with the pair of belt guides in the deployed position;

FIG. 19 is a perspective view of a lock of the removable belt-positioning seat of the child safety seat of FIG. 15, the lock having a pair of latches in a latched position;

FIG. 20 is a perspective view of the lock of FIG. 19 with the pair of latches in an unlatched position;

FIG. 21 is a perspective view of a removable belt-positioning seat according to an embodiment;

FIG. 22 is a perspective view of a lock of the removable belt-positioning seat of FIG. 21;

FIG. 23 is a perspective view of a removable belt-positioning seat according to an embodiment;

FIG. 24 is a perspective view of a lock of the removable belt-positioning seat of FIG. 23;

FIG. 25 is a perspective view of a portion of a sidewall of a seat bottom of the child safety seat of FIG. 1 according to some embodiments, with an object holder removed;

FIG. 26 is a side view of an object holder of FIG. 1;

FIG. 27 is a cross-sectional side view of the portion of the sidewall of FIG. 25, with the object holder installed;

FIG. 28 is a top plan view of the portion of the sidewall of FIG. 25 with the object holder depicted in dashed lines in the extended position;

FIG. 29 is a top plan view of the portion of the sidewall of FIG. 25 with the object holder depicted in dashed lines in the stowed position;

FIG. 30 is a perspective view of a portion of the child safety seat of FIG. 1 according to another example, with an object holder being in an unfixed position;

FIG. 31 is a perspective view of the portion of the child safety seat shown in FIG. 30, with the object holder being in a fixed position; and

FIG. 32 is a cross-sectional top view of the portion of the child safety seat shown in FIG. 30, with the object holder being in the unfixed position.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

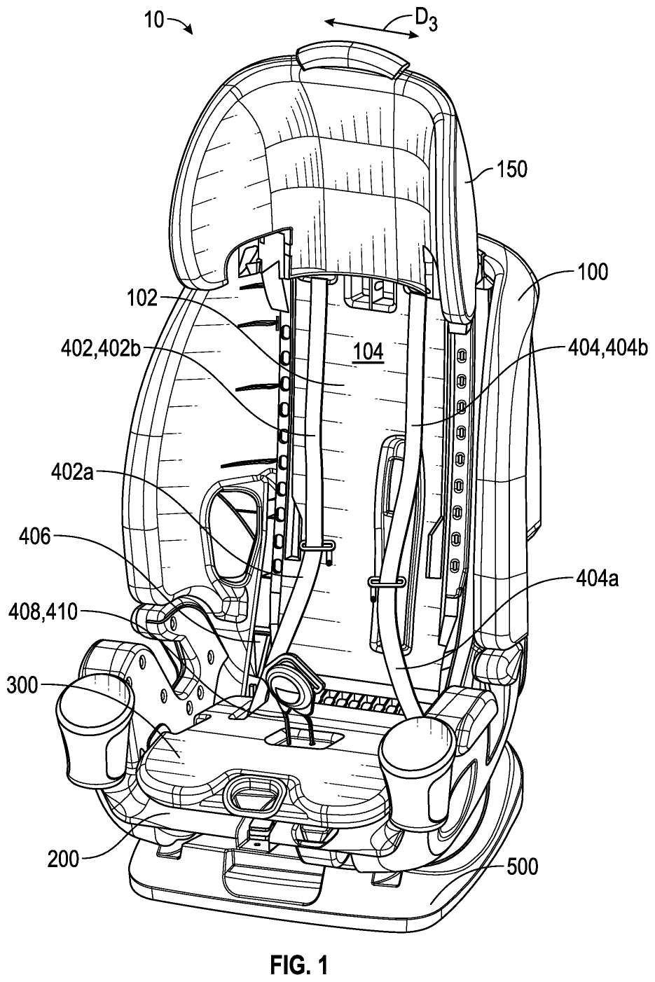

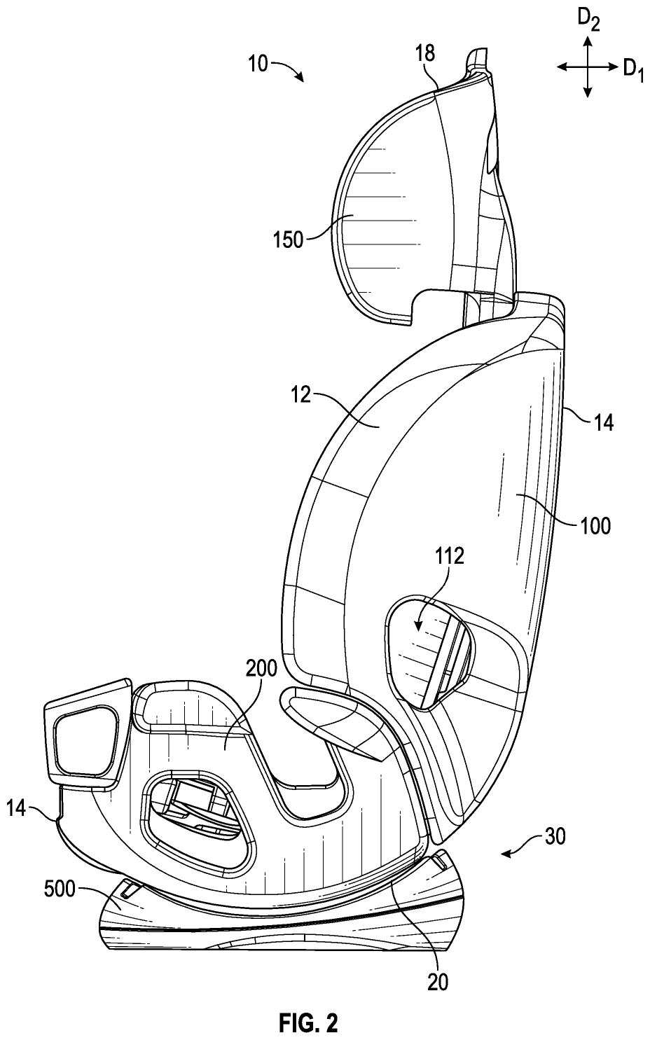

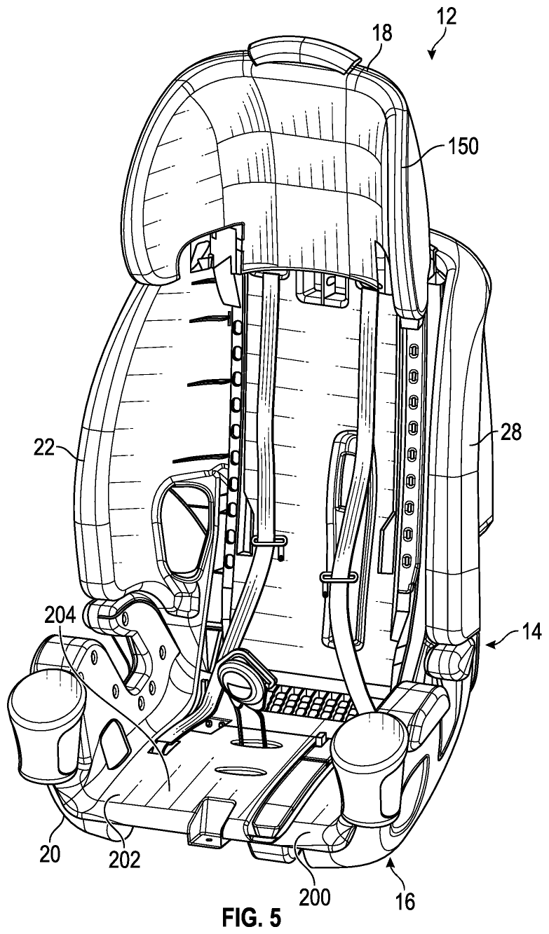

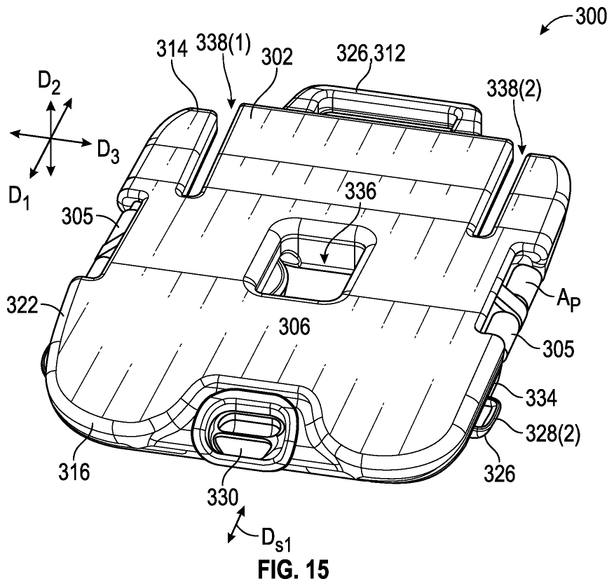

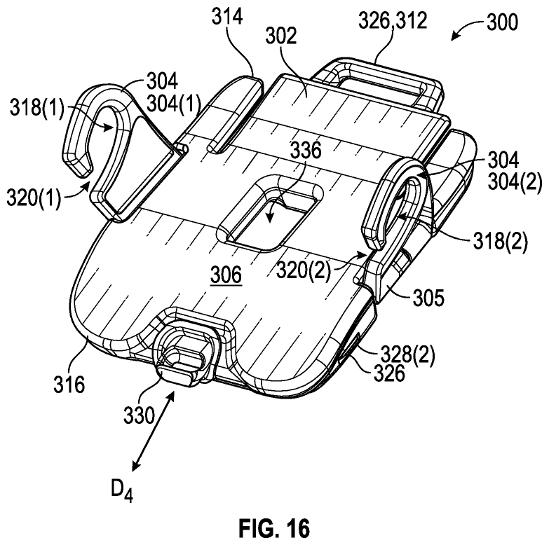

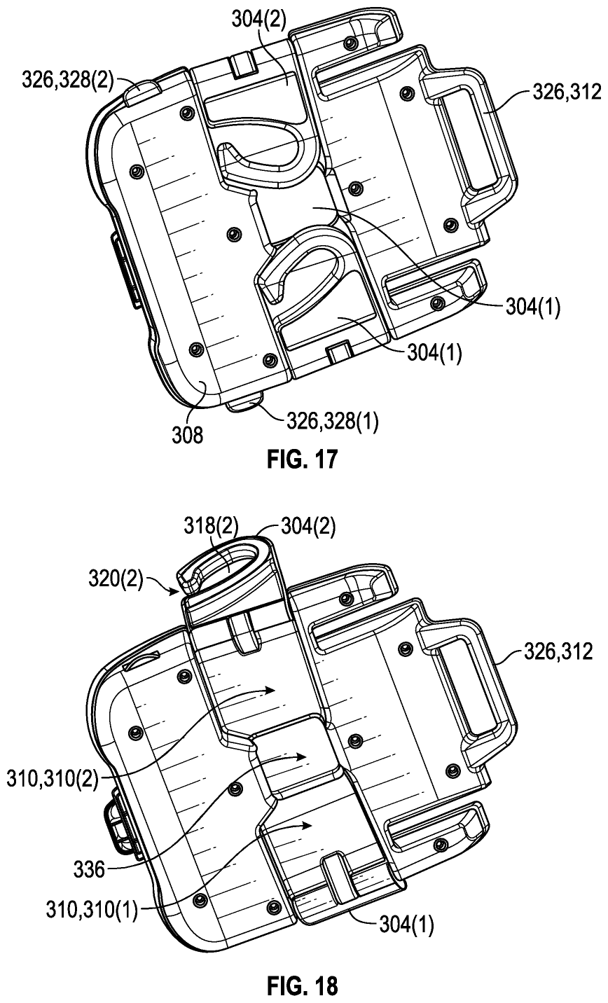

Referring to FIGS. 1 and 2, in some embodiments, a child safety seat 10 (also known as a child car seat) of the present disclosure includes a main seat 12 and a removable belt-positioning seat 300. The main seat 12 has a seatback 100, and a seat bottom 200 attached to the seatback 100. The seat bottom 200 has a first seating surface 202 (labeled in FIG. 5) that defines a receiving space 204 (labeled in FIG. 5). In some embodiments, the child safety seat 10 includes at least one seat cover (not shown) that covers the first seating surface 202. In an embodiment, the at least one seat cover covers a backrest surface 104 of the seatback 100. A removable belt-positioning seat 300 (FIGS. 15 to 18), according to some embodiments, includes a seat body 302 (labeled in FIG. 16) and at least one belt guide 304 (labeled in FIG. 16). The seat body 302 has a second seating surface 306 (labeled in FIG. 16), and a bottom surface 308 (labeled in FIG. 17) that is configured to be placed on a vehicle seat. In some embodiments, the at least one belt guide 304 is configured to be transitioned between a deployed position (FIGS. 16 and 18) in which the at least one belt guide 304 protrudes upward from the second seating surface 306, and a storage position (FIGS. 15 and 17) in which the at least one belt guide 304 is stowed in at least one storage cavity 310 in the seat body 302. The seat body 302 is configured to be removably coupled to the seat bottom 200 within the receiving space 204.

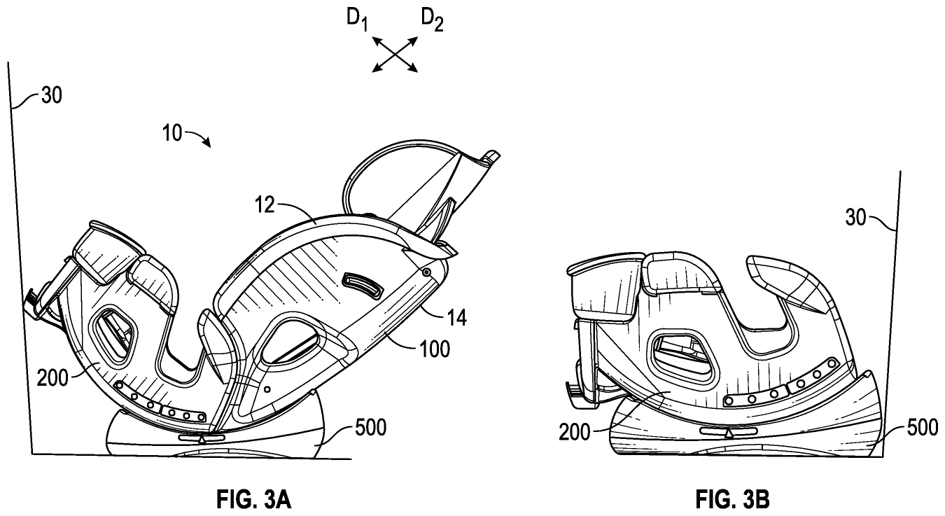

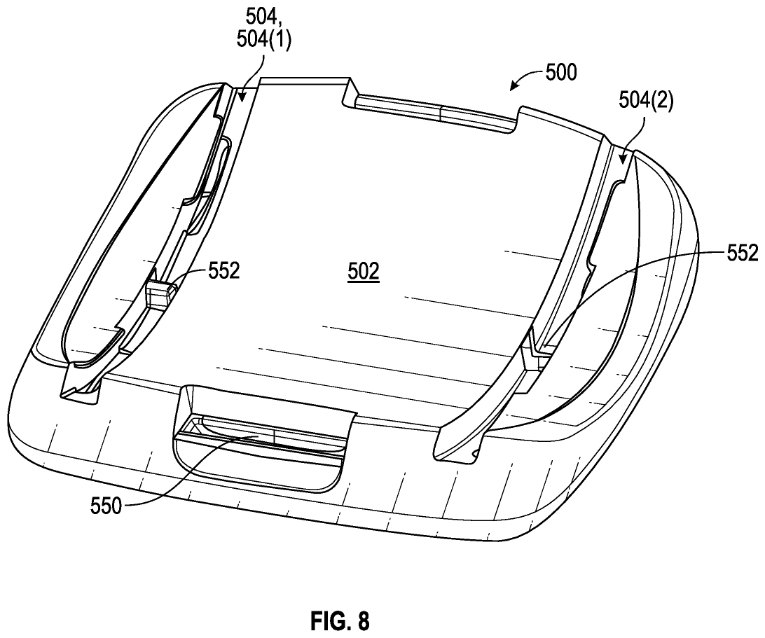

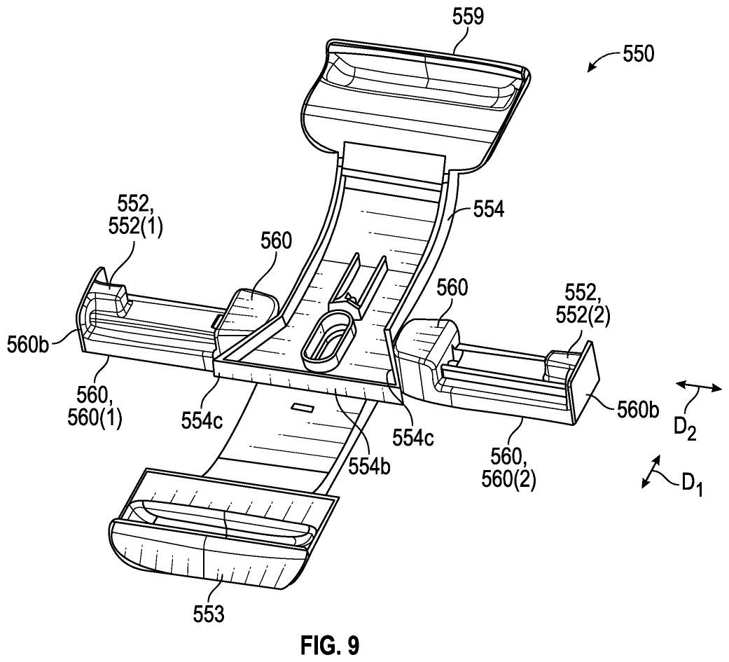

Referring generally still to FIG. 1, in some embodiments, a child safety seat 10 includes a harness 400 including a first strap 402, a second strap 404, and a crotch buckle 406. In some embodiments, the child safety seat 10 is configured such that, when the belt-positioning seat 300 is positioned in the receiving space 204, the crotch buckle 406 is positioned above the second seating surface 306 to removably fasten to the first and second straps 402 and 404. Additionally, or alternatively, in some embodiments, the child safety seat 10 includes a recline base 500 (FIG. 8) and a recline lock 550 (FIG. 9). The recline base 500 is configured to be attached to the seat bottom 200 such that the main seat 12 is configured to move relative to the recline base 500 between an upright configuration (FIG. 2) and a reclined configuration (FIG. 3A). In some embodiments, the recline lock 550 is configured to selectively fix the main seat 12 relative to the recline base 500 in the upright and reclined configuration.

The child safety seat 10 has multiple use configurations. In some embodiments, the child safety seat 10 is a booster seat (without recline base 500) used in a combination of two or more of the following configurations: (1) a forward facing high-back configuration with multi-point (e.g., 5-point) harness and removable-belt positioning seat 300 installed, (2) a forward facing high-back configuration with multi-point (e.g., 5-point) harness and removable-belt positioning seat 300 removed, (3) a forward facing high-back configuration with a vehicle seat belt and removable-belt positioning seat 300 installed, (4) a forward facing high-back configuration with a vehicle seat belt and removable-belt positioning seat 300 removed, (5) a backless booster seat with vehicle seat belt and removable-belt positioning seat 300 installed, or (6) a backless booster seat with vehicle seat belt and removable-belt positioning seat 300 removed. In some embodiments, the removable-belt positioning seat 300 is additionally usable separately from the main seat 12, thereby providing yet another use configuration.

In some other embodiments, the child safety seat 10 is a convertible car seat (with recline base 500) that is used in a combination of two or more of the following configurations: (1) a forward facing high-back configuration with multi-point (e.g., 5-point) harness and removable-belt positioning seat 300 installed, (2) a forward facing high-back configuration with multi-point (e.g., 5-point) harness and removable-belt positioning seat 300 removed, (3) a forward facing high-back configuration with a vehicle seat belt and removable-belt positioning seat 300 installed, (4) a forward facing high-back configuration with a vehicle seat belt and removable-belt positioning seat 300 removed, (5) a backless booster seat with vehicle seat belt and removable-belt positioning seat 300 installed, (6) a backless booster seat with vehicle seat belt and removable-belt positioning seat 300 removed, (7) a rear-facing reclined configuration with the removable-belt positioning seat 300 installed, or (8) a rear-facing reclined configuration with the removable-belt positioning seat 300 removed. In some embodiments, the removable-belt positioning seat 300 is used separately from the main seat 12, thereby providing yet another use configuration. Thus, while the main seat 12 is used by a child in any of the eight use configurations described above, the removable belt-positioning seat 300 is usable by another child.

### Main Seat

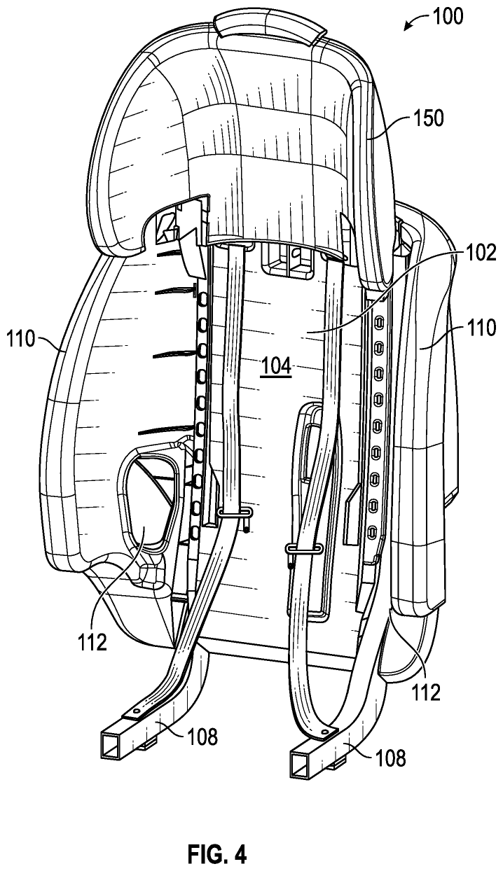

The features of a child safety seat 10 according to various embodiments of the present disclosure will now be discussed in further detail. Referring more specifically to FIGS. 4 and 5, in some embodiments, a child safety seat 10 includes a main seat 12 that has a rear end 14 and a front end 16 offset from one another. The rear and front ends 14 and 16 are offset along a first direction D₁. The main seat 12 is configured such that a child faces in a direction from the rear end 14 toward the front end 16 when the child is seated in the child safety seat 10. The main seat 12 includes an upper end 18 and a lower end 20 offset from one another. The upper and lower ends 18 and 20 are offset along a second direction D₂, perpendicular to the first direction D₁. The main seat 12 is configured such that a child's head is nearer the upper end 18 than the lower end 20 when the child is seated in the child safety seat 10. The main seat 12 includes a first side 22 and a second side 24 offset from one another. The first and second sides 22 and 24 are offset along a third direction D₃, perpendicular to both the first direction D₁ and second direction D₂. The main seat 12 is configured such that the child's arms are adjacent to corresponding first and second sides 22 and 24, when the child is seated in the child safety seat 10.

The main seat 12 has a seatback 100 and a seat bottom 200. The seatback 100 has a seatback body 102. The seatback body 102, and hence the seatback 100, has a backrest surface 104 configured to support a child's back when the child is seated in the child safety seat 10. The backrest surface 104 extends along a direction that extends from the upper end 18 to the lower end 20. The seatback 100 includes a pair of sidewalls 110 spaced from one another along a direction that extends from the first side 22 to the second side 24. The backrest surface 104 is between the sidewalls 110. The sidewalls 110 extend out from the backrest surface 104 along a direction that extends from the rear end 14 to the front end 16 to define a space therebetween for a child's upper body. In some embodiments, each sidewall 110 has a belt-guide opening 112 therethough configured to receive a vehicle seatbelt to secure the child safety seat 10 to a vehicle seat 30 in the forward facing high-back configuration as illustrated in FIG. 2. The seatback 100 includes a headrest 150. The headrest 150 is attached to, or integral with, the seatback body 102. In some embodiments, the headrest 150 is translatable relative to the seatback body 102 between an extended position and a retracted position.

The seatback 100 is configured to be attached to the seat bottom 200 adjacent the lower end 20. In some embodiments, the seatback 100 is fixedly attached to the seat bottom 200. In some other embodiments, the seatback 100 is configured to removably couple to the seat bottom 200 using a suitable seatback coupler or couplers or the like. For instance, in some embodiments, the seatback 100 includes at least one of a protrusion and a recess that engages another of a protrusion and a recess of the seat bottom 200.

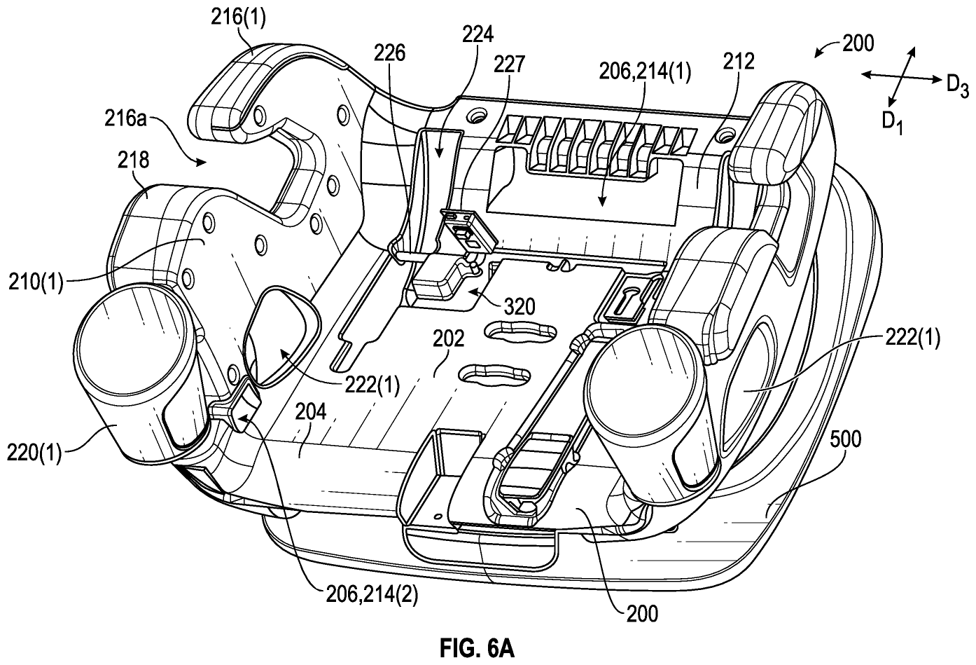

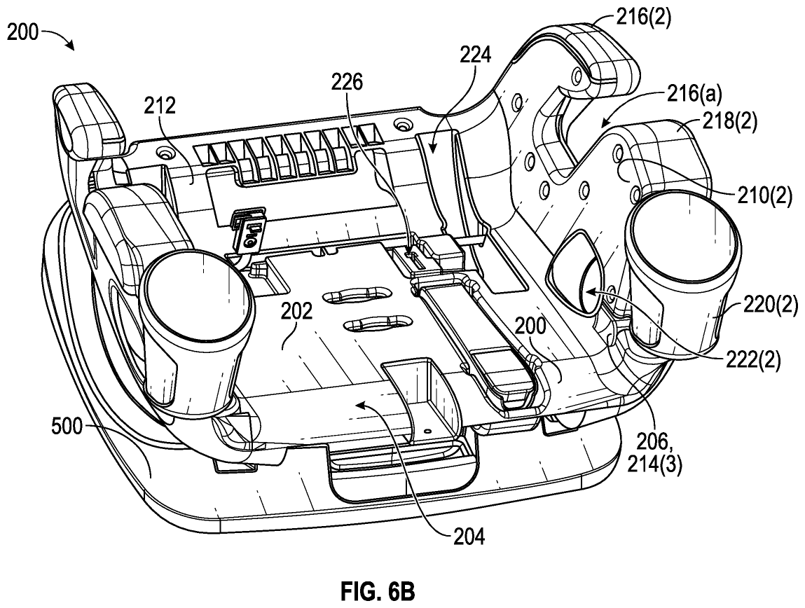

In some embodiments as shown in FIG. 4, the seatback 100 includes at least one support 108, such as a pair of supports 108. Each support 108 is shaped as a tube, bar, or other suitable shape. Each support 108 provides rigidity to the seatback 100. For example, each support 108 is configured to be formed from a suitably rigid material such as metal that has a stiffness that is greater than that of the seatback body 102. Each support 108 extends along and/or behind the backrest surface 104 along a direction that extends from the upper end 18 to the lower end 20. Each support 108 extends from the seatback body 102 beyond the lower end 20, and therefore, each support 108 defines a protrusion. For instance, each support 108 extends from the seatback body 102 along a direction that extends from the upper end 18 to the lower end 20. In some embodiments, each support 108 additionally or alternatively extends outwardly relative to the seatback body 102 along a direction that extends from the rear end 14 to the front end 16. Each support 108 is configured to be removably received in a recess (e.g., 224 in FIGS. 6A and 6B) of the seat bottom 200.

Turning to FIGS. 6A and 6B, in some embodiments, the seat bottom 200 includes a first seating surface 202. The first seating surface 202 at least partially defines a receiving space 204 configured to receive the belt-positioning seat 300. The receiving space 204 is configured to be sized and dimensioned to receive the belt-positioning seat 300. The seat bottom 200 includes at least one pair of sidewalls 210(1) and 210(2) that are spaced apart from one another along the third direction D₃. The first seating surface 202 is between the pair of sidewalls 210(1) and 210(2). The sidewalls 210(1) and 210(2) extend upward from the first seating surface 202. The receiving space 204 is defined between the sidewalls 210(1) and 210(2).

Each sidewall 210(1) and 210(2) defines a corresponding lap belt guide 216(1) and 216(2), (herein referred to as “forward-facing lap belt guides”) configured to position a lap belt portion of a vehicle restraint when the main seat 12 is in a forward-facing (i.e., facing the front of the vehicle) backless booster configuration as in FIG. 3B. The forward-facing lap belt guides 216(1) and 216(2) are spaced apart from one another along the third direction D₃. Each lap belt guide 216(1) and 216(2) is an arm that extends upward from the first seating surface 202. Each lap belt guide 216(1) and 216(2) defines a recess or opening 216a configured to receive a lap belt portion of a vehicle restraint such as a seatbelt. In one example, as shown, the recess or opening 216a is open at the front end of the lap belt guide 216(1) and 216(2) such that the lap belt guide 216(1) and 216(2) has an inverted “L” shape. The receiving space 204 is between the lap belt guides 216(1) and 216(2). The first and second forward-facing belt guides 216(1) and 216(2) is configured to receive a vehicle restraint belt, such as a vehicle seat belt or a separate restraint belt, therethrough to attach the child safety seat 10 to a vehicle seat in a forward-facing configuration.

In addition, or alternatively, in some embodiments, each sidewall 210(1) and 210(2) includes a corresponding armrest 218(1) and 218(2). The armrests 218(1) and 218(2) are spaced apart from one another along the third direction D₃. Each armrest 218(1) and 218(2) is spaced from a respective one of the lap belt guides 216(1) and 216(2) along the first direction D₁. The receiving space 204 is defined between the armrests 218(1) and 218(2). In some embodiments, the child safety seat 10 includes at least one object holder, such as a pair of object holders 220(1) and 220(2). In some embodiments, at least one of the object holders 220(1) and 220(2) is a cup holder. In some embodiments, at least one of the object holders 220(1) and 220(2) is an object holder other than a cup holder, such as a snack holder. Each object holder 220(1) and 220(2) is disposed forward of a corresponding one of the sidewalls 210(1) and 210(2). Each object holder 220(1) and 220(2) is disposed forward of a corresponding one of the armrests 218(1) and 218(2) and/or a corresponding one of lap belt guides 216(1) and 216(2).

In some embodiments, the seat bottom 200 includes first and second belt guides 222(1) and 222(2) (herein referred to as “rear-facing belt guides”) configured to position at least a portion of a vehicle restraint when the main seat 12 is in a rear-facing configuration (i.e., facing the rear of the vehicle). The first rear-facing belt guide 222(1) extends through a first side of the seat bottom 200, such as through the first sidewall 210(1), and the second rear-facing belt guide 222(2) extends through a second side of the seat bottom 200, such as through the second sidewall 210(2). Thus, the first and second rear-facing belt guides 222(1) and 222(2) are spaced from one another along the third direction D₃. The first and second rear-facing belt guides 222(1) and 222(2) are configured to receive a vehicle restraint belt, such as a vehicle seat belt or a separate restraint belt, therethrough to attach the child safety seat 10 to a vehicle seat in a rear-facing configuration. The first and second rear-facing belt guides 222(1) and 222(2) are spaced closer to a front end 16 of the main seat than the rear end 14. The first and second rear-facing belt guides 222(1) and 222(2) are spaced closer to a front end 16 of the main seat than the first and second forward-facing belt guides 216(1) and 216(2).

The seat bottom 200 includes a backwall 212 that at least partially defines the receiving space 204 that receives the belt-positioning seat 300. In some embodiments, the backwall 212 extends upward from the first seating surface 202. The first seating surface 202 defines a bottom surface of the receiving space 204. In some embodiments, the receiving space is defined by a pair of sidewalls 210(1) and 210(2) that are offset from one another along a direction that extends from the first side 22 to the second side 24. The sidewalls 210(1) and 210(2) extend upwards from the first seating surface 202. The seat bottom 200 is configured to receive the belt-positioning seat 300 in the receiving space 204 and removably couple to the belt-positioning seat 300. Seat bottom 200, according to some embodiments, includes at least one coupler 206 configured to fasten the belt-positioning seat 300 to the seat bottom 200. For example, the at least one coupler includes at least two couplers 206 spaced from one another to define two separate fastening points between the belt-positioning seat 300 and the seat bottom 200. Each coupler 206 is at the first sidewall 210(1), the second sidewall 210(2), the backwall 212, or the first seating surface 202.

Each coupler 206 is configured in a suitable matter to fasten the belt-positioning seat 300 to the seat bottom 200. Each coupler 206 includes a securing surface configured to engage a corresponding securing surface of the belt-positioning seat 300 to create an interference between the securing surfaces that fastens the belt-positioning seat 300 to the seat bottom 200. The interference prevents the belt-positioning seat 300 and the seat bottom 200 from moving relative to one another along at least one direction, such as along at least one, up to all, of the first direction D₁, the second direction D₂, and the third direction D₃. Thus, when coupled to the seat bottom 200, the belt-positioning seat 300 is positionally fixed relative to the seat bottom such that movement of the seat bottom causes a corresponding movement of the belt-positioning seat.

Each coupler 206 includes an attachment recess having an inner securing surface configured to engage with an outer securing surface of an attachment protrusion of the belt-positioning seat 300 to secure the belt-positioning seat 300 in the receiving space 204 of the seat bottom 200. Additionally, or alternatively, in some embodiments, each coupler 206 includes an attachment protrusion (not shown) having an outer securing surface configured to engage with an inner securing surface of a recess defined by the belt-positioning seat 300 to secure the belt-positioning seat 300 in the receiving space 204 of the seat bottom 200. In some embodiments (not shown), the attachment protrusion includes a pin, a bar, a hook, or another suitable protrusion. Each coupler 206 is a rigid coupler positionally fixed relative to the body of the seat bottom 200, or is a movable coupler such as a latch configured to move (e.g., retract and extend) relative to the body of the seat bottom 200. In some embodiments (not shown), the at least one coupler 206 includes at least one latch movably attached to the body of the seat bottom 200, and configured to engage with a corresponding attachment recess in the belt-positioning seat 300. The at least one latch is configured to be transitioned between a latched position to fasten the belt-positioning seat 300 to the main seat 12 when received in the receiving space 204 of the main seat, and an unlatched position to unfasten the belt-positioning seat 300 from the main seat 12.

Turning now more specifically to embodiments in FIGS. 6A and 6B, the backwall 212 includes at least one coupler 206 configured to engage with a corresponding coupler of the belt-positioning seat 300 to secure the belt-positioning seat 300 in the receiving space 204. For example, the backwall 212 includes an attachment recess 214(1) configured to engage with a corresponding attachment protrusion 312 of the belt-positioning seat 300 to secure the belt-positioning seat 300 in the receiving space 204. The attachment recess 214(1) is configured to receive the attachment protrusion 312 along a direction extending from the front end 16 to the rear end 14. When the attachment protrusion 312 is received in the attachment recess 214(1), the attachment protrusion 312 is prevented from moving out of the attachment recess 214(1) along the second direction D₂.

The first sidewall 210(1) includes at least one coupler 206 configured to engage with a corresponding coupler of the belt-positioning seat 300 to secure the belt-positioning seat 300 in the receiving space 204. For example, the first sidewall 210(1) includes an attachment recess 214(2) configured to engage with a corresponding attachment protrusion 328(1) of the belt-positioning seat 300 to secure the belt-positioning seat 300 in the receiving space 204. The attachment recess 214(2) is configured to receive the attachment protrusion 328(1) along the third direction D₃. When the attachment protrusion 328(1) is received in the attachment recess 214(2), the attachment protrusion 328(1) is prevented from moving out of the attachment recess 214(2) along the first direction D₁ and the second direction D₂.

The second sidewall 210(1) includes at least one coupler 206 configured to engage with a corresponding coupler of the belt-positioning seat 300 to secure the belt-positioning seat 300 in the receiving space 204. For example, the second sidewall 210(2) includes an attachment recess 214(3) configured to engage with a corresponding attachment protrusion 328(2) of the belt-positioning seat 300 to secure the belt-positioning seat 300 in the receiving space 204. The attachment recess 214(3) is configured to receive the attachment protrusion 328(2) along the third direction D₃. When the attachment protrusion 328(2) is received in the attachment recess 214(3), the attachment protrusion 328(2) is prevented from moving out of the attachment recess 214(3) along the first direction D₁ and the second direction D₂.

The seat bottom 200 includes at least one seatback coupler configured to couple the seat bottom 200 to the seatback 100. In some embodiments, the at least one seatback coupler includes at least one of a protrusion and a recess that engages another of a protrusion and a recess of the seatback 100. In the embodiments of FIGS. 6A-6B, the seat bottom 200 includes at least one seatback coupling recess 224, such as a pair of seatback coupling recesses 224. The seatback coupling recesses 224 are spaced from one another along the third direction D₃. Each seatback coupling recess 224 is configured to receive a corresponding support 108 of the seatback 100 therein.

The main seat 12 includes at least one seatback latch 226 configured to fasten the seatback 100 to the seat bottom 200 so that the seatback 100 and seat bottom are positionally fixed relative to one another. In some embodiments, each seatback latch 226 includes a rod extending through a hole in a corresponding one of the supports 108 along the third direction D₃. Each seatback latch 226 is configured to be moved into and out of engagement with a corresponding one of the supports 108. For example, each seatback latch 226 is configured to be translated back and forth along the third direction D₃ to insert the rod into the hole in the corresponding support 108 and remove the rod from the hole. In some embodiments, each seatback latch 226 has a lock 227 configured to lock a position of the latch 226. For example, each lock 227 is configured to be rotated into a pocket 229 in the seat bottom 200 to lock a position of the latch 226 along the third direction D₃ and out of the pocket 229 to allow the latch 226 to translate along the third direction D₃. However, in other embodiments, the at least one seatback latch 226 is implemented in another suitable manner.

Referring back to FIG. 1, the child safety seat 10 includes a harness 400 to secure a child in the seat 10. The harness 400 includes a crotch strap 408. The crotch strap 408 includes a crotch buckle 406 and a webbing 410. The harness 400 includes a first strap 402 and a second strap 404 that are configured to selectively fasten to the crotch buckle 406. The first strap 402 includes a lap belt portion 402a configured to rest over a lap of a child and/or a shoulder belt portion 402b configured to rest over a shoulder of a child. The first strap 402 includes a terminal end attached to the main seat 12 at a location below the belt-positioning seat 300. For example, the first strap 402 is configured to be attached to a lower end of one of the supports 108 as shown in FIGS. 4 and 5. Similarly, the second strap 404 includes a lap belt portion 404a configured to rest over a lap of a child and/or a shoulder belt portion 404b configured to rest over a shoulder of a child. The second strap 404 includes a terminal end attached to the main seat 12 at a location below the belt-positioning seat 300. For example, the second strap 404 is configured to be attached to a lower end of one of the supports 108 as shown in FIGS. 4 and 5.

The shoulder belt portions 402a and 402b are repositionable for differently sized children. In some embodiments, the upper ends of the shoulder belt portions 402a and 402b are configured to be raised for taller children, and lowered for shorter children. Thus, the shoulder belt portions 402a and 402b have an upper-most position and a lower-most position. Further, the child safety seat 10 is configured to define a distance between the upper-most position and the lower-most position. The distance is configured to be greater than that of a conventional child safety seat that does not include a removable belt-positioning seat. In some embodiments, the highest position is configured to account for the tallest child when the belt-positioning seat 300 is installed, and the lowest position is configured to account for the shortest child when the belt-positioning seat 300 is removed.

### Recline Base

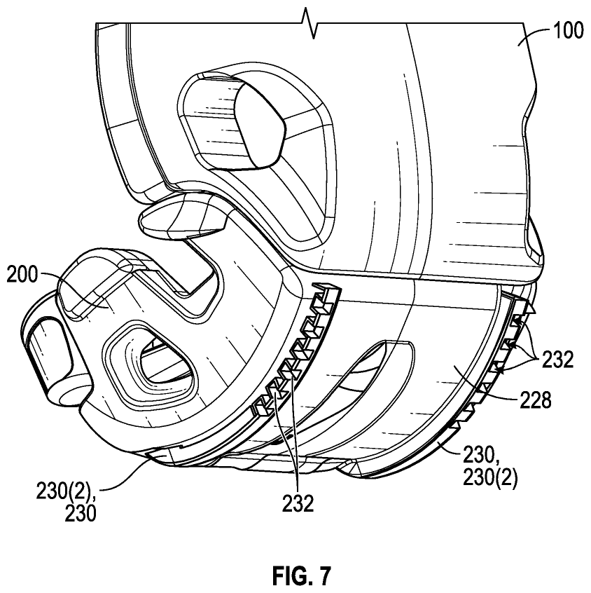

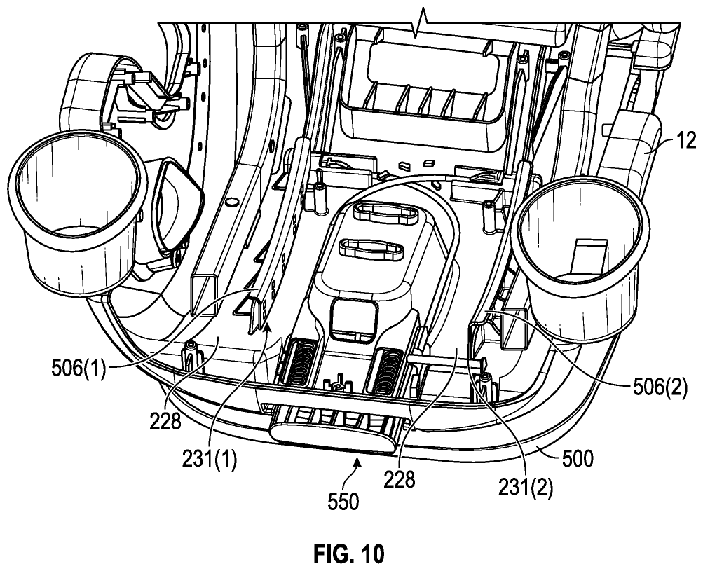

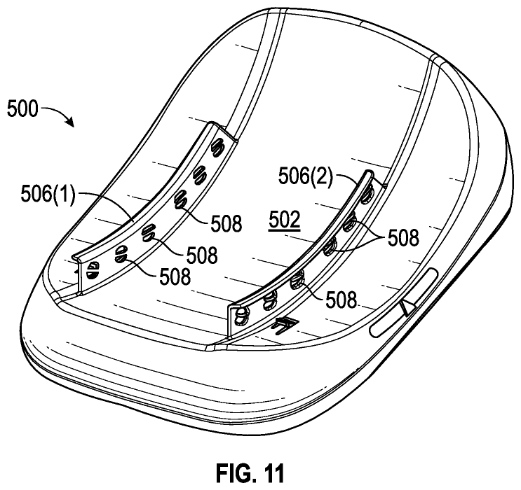

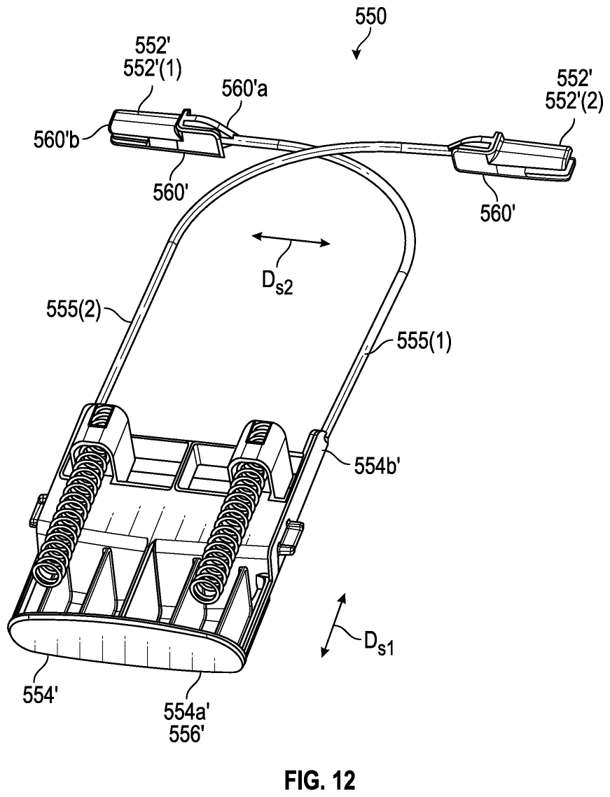

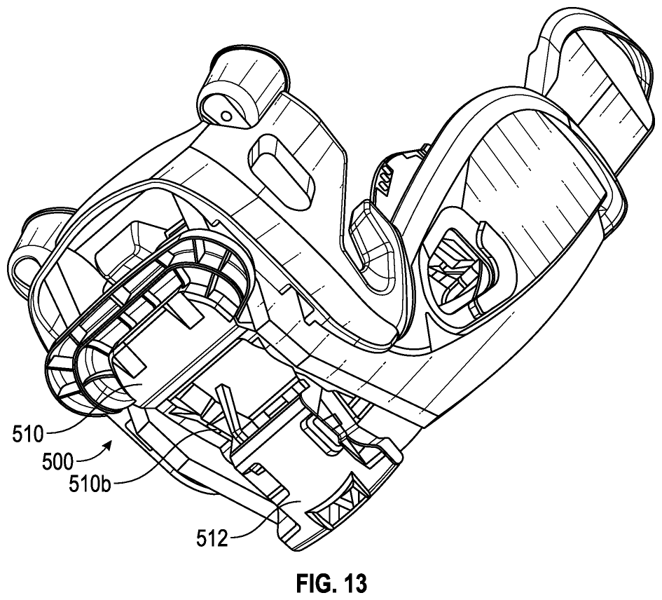

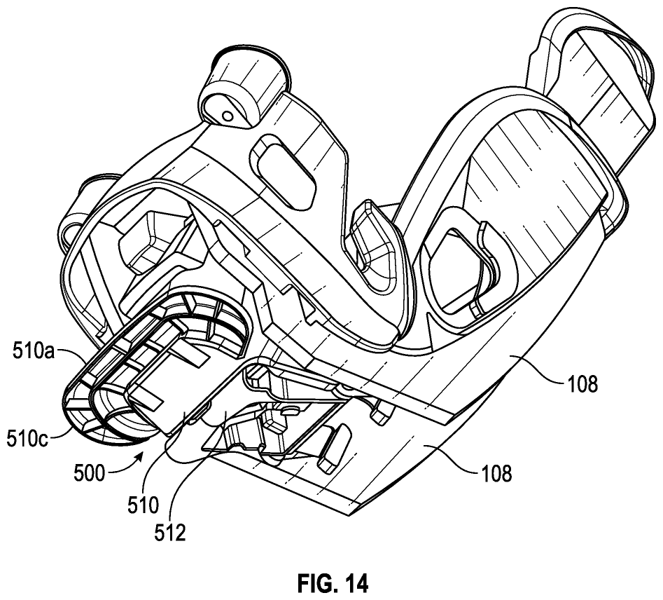

Turning to FIGS. 7 to 14, in some embodiments, the child safety seat 10 includes a recline base 500 attached to the main seat 12 such that the main seat 12 is configured to move relative to the recline base 500 between an upright position (as shown in FIG. 2) and a reclined configuration (as shown in FIG. 3A). FIGS. 7 to 9 show a recline base 500 according to some embodiments, FIGS. 10 to 12 show a recline base 500′ according to some embodiments, and FIGS. 13 and 14 show a recline base 500″ according to some embodiments. The recline base is configured to be a suitable recline base. In some embodiments, the child safety seat 10 further includes a lock (e.g., 550, 550′, 550″) configured to selectively fix the main seat 12 relative to the base (e.g., 500, 550′, 550′) in the upright and reclined configurations. The lock is configured to be a suitable lock. In some embodiments, as shown in FIG. 10, the lock 550′ is carried by the main seat 12. In some other embodiments, as shown in FIG. 8, the lock 550 is carried by the recline base 500.

Referring more specifically to some embodiments of FIGS. 7 to 9, the main seat 12 has a bottom surface 228 that is curved, and the recline base 500 includes an upper surface 502 that is curved to conform to the bottom surface 228 of the main seat 12. The bottom surface 228 of the main seat 12 is configured to translate along the upper surface 502 of the recline base 500 to transition the main seat 12 between the upright configuration and the reclined configuration. The main seat 12 has at least one rail 230 extending down from the bottom surface 228. The recline base 500 has at least one channel 504 configured to receive the at least one rail 230. The at least one rail 230 is configured to translate within the at least one channel 504 as the main seat 12 transitions between the upright configuration and the reclined configuration. In some embodiments, the at least one rail 230 includes first and second rails 230(1) and 230(2) that are spaced apart from one another along the third direction D₃, and the recline base 500 includes first and second channels 504(1) and 504(2) configured to receive corresponding first and second rails 230(1) and 230(2).

The child safety seat 10 in some embodiments of FIGS. 7 to 9 includes a lock 550 configured to selectively lock the main seat 12 relative to the recline base 500 in the upright and reclined configurations. The lock 550 is configured to engage the at least one rail 230 to selectively lock the main seat 12 relative to the recline base 500 in the upright and reclined configurations. In some embodiments, each of the at least one rail 230 includes a plurality of locking openings 232 spaced apart from one another along a length of the rail 230. Each locking opening 232 corresponds to a different recline configuration of the main seat 12, including the upright configuration. In some embodiments, the lock 550 has at least one protrusion 552 configured to be selectively received in the locking openings 232 to fix a position of the main seat 12 relative to the recline base 500.

In some embodiments, the lock 550 includes at least one latch 560 movably attached to the recline base 500. The lock 550 includes an actuator 554 configured to be engaged by a user to transition the at least one latch 560 between a latched position in which the at least one latch 560 engages the main seat 12 to fix a position of the main seat 12 relative to the recline base 500, and an unlatched position in which the main seat 12 is free to recline relative to the recline base 500. In some embodiments, the actuator 554 includes an actuation surface, such as a handle or button, configured to be engaged by the user to actuate the actuator 554. In some embodiments, the actuator 554 is configured such that movement of the actuator 554 along a first select direction D_{S1} causes movement of the at least one latch 560 along a second select direction D_{S2}. In some embodiments, the first select direction D_{S1} is the first direction D₁ and the second select direction D_{S2} is the third direction D₃.

In some embodiments, the at least one movable latch 560 includes a first movable latch 560(1). The first movable latch 560(1) includes a first protrusion 552(1) of the at least one protrusion 552. The first movable latch 560(1) is configured to engage the first rail 230(1). The first movable latch 560(1) has an inner end 560a and an outer end 560b. The first protrusion 552(1) is disposed at the outer end 560b. The inner end 560a is configured to be engaged by the actuator 554. In some embodiments, the at least one movable latch 560 includes a second movable latch 560(2). The second movable latch 560(2) includes a second protrusion 552(2) of the at least one protrusion 552. The second latch 560(2) is configured to engage the second rail 230(2). The second movable latch 560(2) has an inner end 560a and an outer end 560b. The second protrusion 552(2) is at the outer end 560b. The inner end 560a is configured to be engaged by the actuator 554.

The actuator 554 includes an outer end 554a that defines an actuation surface 556 configured to be engaged by a user. In some embodiments, the actuator 554 includes a handle or a button that defines the actuation surface 556. The actuation surface 556 is configured to be movable along the first select direction D_{S1} to move the at least one movable latch 560 between the latched and unlatched positions. The actuator 554 includes an inner end 554b within the lock 550. The inner end 554b is configured to be coupled to the at least one movable latch 560 such that movement of the actuator 554 along the first select direction D_{S1} causes movement of the at least one latch 560 along the second select direction D_{S2}. One of the actuator 554 and the at least one latch 560 has at least one ramped surface 554c angled relative to the first select direction D_{S1}. The ramped surface 554c is configured to engage the other one of the actuator 554 and the at least one latch 560 to transition the at least one latch 560 between the latched and unlatched positions. In some embodiments, the lock 550 includes a second actuator 558. The second actuator 558 is configured in a manner similar to the first actuator 554. However, the second actuator 558 is configured to be actuated in a direction opposite the first actuator 558. Thus, one of the first and second actuators 554 and 558 is configured to be engaged by a user at a front end of the recline base 500, and the other one of the first and second actuators 554 and 558 is configured to be engaged by a user at a rear end of the recline base 500.

Turning to FIGS. 10 to 12, in some embodiments, the main seat 12 similarly has a bottom surface 228 that is curved, and the recline base 500′ includes an upper surface 502 that is curved to conform to the bottom surface 228 of the main seat 12. The bottom surface 228 of the main seat 12 is configured to translate along the upper surface 502 of the recline base 500′ to transition the main seat 12 between the upright configuration and the reclined configuration. The recline base 500′ has at least one rail 506(1), 506(2) extending upward from the upper surface 502 of the recline base 500. The main seat 12 includes at least one channel 231(1), 231(2) configured to receive the at least one rail 506(1), 506(2). The at least one rail 506(1), 506(2) is configured to translate within the at least one channel 231(1), 231(2) as the main seat 12 transitions between the upright configuration and the reclined configuration. In some embodiments, the at least one rail 506(1), 506(2) includes first and second rails 506(1) and 506(2) that are spaced apart from one another along the third direction D₃, and the recline base 500′ includes first and second channels 231(1) and 231(2) that are configured to receive the corresponding first and second rails 506(1) and 506(2).

The child safety seat 10 in some embodiments of FIGS. 10 to 12 includes a lock 550′ configured to selectively lock the main seat 12 relative to the recline base 500′ in the upright and reclined configurations. The lock 550′ is configured to engage the at least one rail 506(1), 506(2) to selectively lock the main seat 12 relative to the recline base 500′ in the upright and reclined configurations. In some embodiments, each of the at least one rail 506(1), 506(2) includes a plurality of locking openings 508 that are spaced apart from one another along a length of the rail 506(1), 506(2). Each locking opening 508 corresponds to a different recline configuration of the main seat 12, including the upright configuration. The lock 550′ has at least one protrusion 552′ configured to be selectively received in the locking openings 232 to fix a position of the main seat 12 relative to the recline base 500′.

The lock 550′ includes at least one latch 560′ movably attached to the main seat 12. The lock 550′ includes an actuator 554′ configured to be engaged by a user to transition the at least one latch 560′ between a latched position in which the at least one latch 560′ engages the recline base 500′ to fix a position of the main seat 12 relative to the recline base 500′, and an unlatched position in which the main seat 12 is free to recline relative to the recline base 500′. The actuator 554′ includes an actuation surface, such as a handle or button, configured to be engaged by the user to actuate the actuator 554′. In some embodiments, the actuator 554′ is configured such that movement of the actuator 554′ along a first select direction D_{S1} causes movement of the at least one latch 560 along a second select direction D_{S2}. In some embodiments, the first select direction D_{S1} is the first direction D₁ and the second select direction D_{S2} is the third direction D₃.

The at least one movable latch 560′ includes a first movable latch 560′(1). The first movable latch 560′ includes a first protrusion 552′(1) of the at least one protrusion 552′. The first latch 560′(1) is configured to engage the first rail 506(1). The first movable latch 560′(1) has an inner end 560a′ and an outer end 560b′. The first protrusion 552′(1) is at the outer end 560b′. The inner end 560a′ is configured to be engaged by the actuator 554′. In some embodiments, the actuator 554′ includes a wire or strand 555(1) operatively coupled to an actuation surface 556′ of the actuator 554′ and the inner end 560a′ such that movement of the actuator 554′ causes movement of the first moveable latch 560′(1). In some embodiments, the at least one movable latch 560′ includes a second movable latch 560′(2). The second movable latch 560′(2) includes a second protrusion 552′(2) of the at least one protrusion 552′. The second latch 560′(2) is configured to engage the second rail 506(2). The second movable latch 560′(2) has an inner end 560a′ and an outer end 560b′. The second protrusion 552′(2) is at the outer end 560b′. The inner end 560a′ is configured to be engaged by the actuator 554′. In some embodiments, the actuator 554′ includes a wire or strand 555(1) operatively coupled to the actuation surface 556′ and the inner end 560a′ such that movement of the actuator 554′ causes movement of the first moveable latch 560′(1).

The actuator 554′ includes an outer end 554a′ that defines the actuation surface 556′ configured to be engaged by a user. The actuator 554′ includes a handle or a button that defines the actuation surface 556′. The actuation surface 556′ is configured to be movable along the first select direction D_{S1} to move the at least one movable latch 560′ between the latched and unlatched positions. The actuator 554′ includes an inner end 554b′ disposed within the main seat 12. The inner end 554b′ is configured to be coupled to the at least one movable latch 560′ such that movement of the actuator 554′ along the first select direction D_{S1} causes movement of the at least one latch 560′ along the second select direction D_{S2}.

Turning to FIGS. 13 and 14, in some embodiments, the recline base 500″ includes at least one foot 510, 512 rotatably or translatably coupled to the main seat 12 such that the at least one foot 510, 512 moves relative to the main seat 12 to transition the main seat 12 between the reclined and upright configurations. The at least one foot 510, 512 includes a first foot 510 having a front end 510a and a rear end 510b. The at least one foot 510 is configured to be coupled to the main seat 12 at the rear end 510b or at a position between the front end 510a and the rear end 510b. The front end 510a has a support surface 510c configured to abut the vehicle seat. The front end 510a is configured such that the support surface 510c is movable away from the main seat 12 to transition the main seat 12 to a more reclined configuration and toward the main seat 12 to transition the main seat 12 to a more upright configuration. In some embodiments, the recline base 500″ includes a second foot 512 having a first end 512a pivotably coupled to the first foot 510 and/or main seat 12, and a second end 512b configured to rotate relative to the main seat 12. An example of the recline base 500″ is described in U.S. patent publication 2020/0223332, the disclosure of which is hereby incorporated by reference as if set forth in its entirety herein.

### Belt-Positioning Seat

Referring to FIGS. 15 to 18, a removable belt-positioning seat 300 is shown according to some embodiments. The belt-positioning seat 300 includes a seat body 302. The seat body 302 includes a second seating surface 306 and a bottom surface 308 that are opposite one another. In some embodiments, the second seating surface 306 and a bottom surface 308 are opposite one another along the second direction D₂. The seat body 302 includes a rear end 314 and a front end 316 that are offset from one another. In some embodiments, the rear and front ends 314 and 316 are offset along the first direction D₁. The belt-positioning seat 300 is configured such that a child faces in a direction from the rear end 314 towards the front end 316 when the child is seated in the belt-positioning seat 300. The belt-positioning seat 300 includes a first side 322 and a second side 324 that are offset from one another. In some embodiments, the first and second sides 322 and 324 are offset along the third direction D₃. The belt-positioning seat 300 has a substantially plate-like shape. In some embodiments, in contrast to the main seat 12, the belt-positioning seat 300 is configured to be devoid of a seatback, armrests, and/or cup holders.

The belt-positioning seat 300 includes at least one belt guide 304, such as a pair of belt guides 304. The at least one belt guide 304 includes a first belt guide 304(1). The first belt guide 304(1) is configured to be movably coupled to the first side 322 of the seat body 302 such that the first belt guide 304(1) is configured to transition between a deployed position (FIG. 16) in which the first belt guide 304(1) protrudes upward from the second seating surface 306, and a storage position (FIG. 17) in which the first belt guide 304(1) is stowed in at least one storage cavity 310 defined in the seat body 302. In some embodiments, the first belt guide 304(1) is pivotably coupled to the seat body 302 such that the first belt guide 304(1) is configured to rotate about an axis A_{P} that extends along the first direction D₁. The belt-positioning seat 300 includes a hinge 305 that couples the first belt guide 304(1) to the seat body 302. In some other embodiments, the first belt guide 304(1) is configured to be transitioned between the deployed and storage positions without rotating or by rotating and moving in another manner (e.g., translating).

The first belt guide 304(1) is a rigid body that extends upward from the seat body 302 when in the deployed position. In some embodiments, the first belt guide 304(1) is attached to the seat body 302 along a middle portion of the seat body 302 between the front and rear ends 316 and 314 such that the first belt guide 304(1) is spaced from the front and rear ends 316 and 314. In some embodiments, the rigid body can have a plate-like shape. The first belt guide 304(1) has a first belt hole 318(1) configured to receive a restraining belt, such as a lap belt of a vehicle seatbelt. The first belt hole 318(1) is spaced above the second seating surface 306 to position the retraining belt over a child's lap when the first belt guide 304(1) is in the deployed position. The first belt hole 318(1) extends through the first belt guide 304(1).

In some embodiments, the first belt guide 304(1) has an inner side that faces the child when in the deployed position, and an outer side opposite the inner side. The first belt hole 318(1) extends through the inner and outer sides. In some embodiments, the first belt guide 304(1) has a first opening 320(1) at the front end of the first belt guide 304(1) open to the first belt hole 318(1). The first belt hole 318(1) is closed at a rear end of the first belt guide 304(1). In some embodiments, the restraining belt is received through the first opening 320(1) and into the first belt hole 318(1) along a direction that extends from the front end 316 of the belt-positioning seat 300 to the rear end 314. The first opening 320(1) has a dimension, such as a height, less than a dimension of the first belt hole 318(1) to provide an interference that restricts inadvertent removal of the restraining belt from the first belt hole 318(1).

The at least one belt guide 304 includes a second belt guide 304(2). The second belt guide 304(2) is offset from the first belt guide 304(1) along the third direction D₃. The second belt guide 304(2) is configured to be movably coupled to the second side 324 of the seat body 302 such that the second belt guide 304(2) is configured to transition between a deployed position (FIG. 16) in which the second belt guide 304(2) protrudes upward from the second seating surface 306, and a storage position (FIG. 17) in which the second belt guide 304(2) is stowed in at least one storage cavity 310 in the seat body 302. In some embodiments, the second belt guide 304(2) is configured to be pivotably coupled to the seat body 302 such that the second belt guide 304(2) is configured to rotate about an axis A_{P} that extends along the first direction D₁. The belt-positioning seat 300 includes a hinge 305 that couples the second belt guide 304(2) to the seat body 302. In some other embodiments, the second belt guide 304(2) is configured to be transitioned between the deployed and storage positions without rotating or by rotating and moving in another manner (e.g., translating).

The second belt guide 304(2) is a rigid body that extends upward from the seat body 302 when in the deployed position. In some embodiments, the second belt guide 304(2) is configured to be attached to the seat body 302 along a middle portion of the seat body 302 between the front and rear ends 316 and 314 such that the second belt guide 304(2) is spaced from the front and rear ends 316 and 314. In some embodiments, the rigid body has a plate-like shape. The second belt guide 304(2) has a second belt hole 318(2) configured to receive a restraining belt, such as a lap belt of a vehicle seatbelt. The second belt hole 318(2) is spaced above the second seating surface 306 to position the retraining belt over a child's lap when the second belt guide 304(2) is in the deployed position. The second belt hole 318(2) extends through the second belt guide 304(2).

In some embodiments, the second belt guide 304(2) has an inner side configured to face the child when in the deployed position, and an outer side opposite the inner side. The second belt hole 318(2) extends through the inner and outer sides. In some embodiments, the second belt guide 304(2) has a second opening 320(2) at the front end of the second belt guide 304(2) open to the second belt hole 318(2). The second belt hole 318(2) is closed at a rear end of the second belt guide 304(2). In some embodiments, the restraining belt is received through the second opening 320(2) and into the second belt hole 318(2) along a direction extending from the front end 316 of the belt-positioning seat 300 to the rear end 314. The second opening 320(2) has a dimension, such as a height, less than a dimension of the second belt hole 318(2) to provide an interference that restricts inadvertent removal of the restraining belt from the second belt hole 318(2).

The seat body 302 has the at least one storage cavity 310, such as a pair of storage cavities therein. The at least one storage cavity 310 includes a first storage cavity 310(1). The first storage cavity 310(1) is configured to receive the first belt guide 304(1) to store the first belt guide 304(1) therein. The first storage cavity 310(1) extends into the bottom surface 308 of the seat body 302, although embodiments in this disclosure are not so limited. For instance, in other embodiments, the first storage cavity 310(1) extends into the first side 322 and is closed at the bottom surface 308. The first belt guide 304(1) is then configured to translate out of the storage cavity 310 and rotate to protrude upwards.

The at least one storage cavity 310 includes a second storage cavity 310(2). The second storage cavity 310(2) is spaced from the first storage cavity 310(1) along the third direction D₃. The second storage cavity 310(2) is configured to receive the second belt guide 304(2) to store the second belt guide 304(2) therein. The second storage cavity 310(2) extends into the bottom surface 308 of the seat body 302, although embodiments of the present disclosure are not so limited. For instance, in other embodiments, the second storage cavity 310(2) extends into the second side 322 and is closed at the bottom surface 308. The second belt guide 304(2) is then configured to translate out of the storage cavity 310 and rotate to protrude upwards. In alternative embodiments, the seat body 302 has a single storage cavity that stores both the first and second belt guides 304(1) and 304(2).

The seat body 302 is configured to be removably coupled to the seat bottom 200 of the main seat 12 in the receiving space 204 of the seat bottom 200. In some embodiments, belt-positioning seats include at least two couplers 326 configured to fasten the belt-positioning seat 300 to the seat bottom 200. The at least two couplers 326 are spaced from one another to define two separate fastening points between the belt-positioning seat 300 and the seat bottom 200. Each coupler 326 is disposed at the first side 322, the second side 324, the rear end 314, or the bottom surface 308.

Each coupler 326 is configured in any suitable matter to fasten the belt-positioning seat 300 to the seat bottom 200). Each coupler 326 includes a securing surface configured to engage a corresponding securing surface of the seat bottom 200 to create an interference between the securing surfaces that fastens the belt-positioning seat 300 to the seat bottom 200. The interference prevents the belt-positioning seat 300 and the seat bottom 200 from moving relative to one another along at least one direction, such as along at least one, up to all, of the first direction D₁, the second direction D₂, and the third direction D₃. Each coupler 326 includes an attachment protrusion having an outer securing surface configured to engage with an inner securing surface of a recess in the seat bottom 200 to secure the belt-positioning seat 300 in the receiving space 204 of the seat bottom 200. Additionally, or alternatively, in some embodiments, each coupler 326 includes an attachment recess having an inner securing surface configured to engage with an outer securing surface of an attachment protrusion of the seat bottom 200 to secure the belt-positioning seat 300 in the receiving space 204 of the seat bottom 200. In some embodiments, the attachment protrusion is a pin, a bar, a hook, or any other suitable protrusion. Each coupler 326 is a rigid coupler positionally fixed relative to the seat body 302 of the belt-positioning seat 300, or is a movable coupler such as a latch configured to move (e.g., retract and extend) relative to the seat body 302.

In some embodiments, at least one of the couplers 326 includes a rigid protrusion 312 rigidly attached to the first side 322, the second side 324, the rear end 314, or the bottom surface 308 of the seat body 302, and configured to engage with a corresponding attachment recess 214(1) (FIGS. 6A and 6B) defined in the seat bottom 200. The protrusion 312 is integral and monolithic with the seat body 302 or otherwise rigidly attached thereto. In some embodiments, the rigid protrusion 312 is in the shape of a handle. In some embodiments, the handle defines a “u” shape. In some embodiments, the protrusion 312 extends from the rear end 314 of the belt-positioning seat 300. In some other embodiments, the protrusion 312 extends from one of the first or second sides 322 or 324.

In some embodiments, the at least one coupler 326 includes at least one latch 328(1) or 328(2) movably attached to the seat body 302, and configured to engage with a corresponding attachment recess (e.g., 214(2), 214(3) of FIGS. 6A and 6B) in the seat bottom 200. The at least one latch 328(1) or 328(2) is configured to be transitioned between a latched position (FIG. 15) so as to fasten the belt-positioning seat 300 to the main seat 12 when received in the receiving space 204 of the main seat 12, and an unlatched position (FIG. 16) to unfasten the belt-positioning seat 300 from the main seat 12. The at least one latch 328(1) or 328(2), in some embodiments, is configured to extend out further from the seat body 302 in the latched position than in the retracted position. In some embodiments, the at least one latch 328(1) or 328(2) extends from at least one of the first side 322, the second side 324, the rear end 314, the front end 316, or the bottom surface 308 of the seat body 302. In some embodiments, the at least one latch 328(1) or 328(2) includes a plurality of latches 328(1), 328(2).

According to some embodiments, a belt-positioning seat 300 includes an actuator 330 configured to be engaged by a user so as to transition the at least one latch 328(1) or 328(2) between the latched and unlatched positions. The actuator 330 includes an actuation surface, such as a handle or button, configured to be engaged by the user to actuate the actuator 330. The at least one latch 328(1) or 328(2) and the actuator 330 are configured to be implemented in any suitable manner. In some other embodiments, the actuator and latches are carried by the seat bottom 200, rather than the belt-positioning seat 300.

Turning more specifically to FIGS. 15, 19, and 20, the at least two couplers 326 and the actuator 330 according to some embodiments are shown. In some embodiments, the at least two couplers 326 include a protrusion 312 that extends from the rear end 314 of the seat body 302. The protrusion 312 is a rigid coupler positionally fixed relative to the seat body 302 of the belt-positioning seat 300. The protrusion 312 defines a handle. In some embodiments, the handle has an opening therethrough for receiving a user's finger(s) when carrying the belt-positioning seat 300. In some embodiments, the handle can have a “u” shape. In some other embodiments, the protrusion 312 need not define a handle and has other shapes (e.g., “L” shape or “T” shape). The protrusion 312 is configured to be received in an attachment recess 214(1) in the backwall 212 of the seat bottom 200 (see FIGS. 6A and 6B). The protrusion 312 has a securing surface, such as an outer surface of the handle, that engages an inner surface of the recess 214(1) along the second direction D₂ to prevent the protrusion 312 from moving relative to the seat bottom 200 along the second direction D₂.

The at least two couplers 326 include at least one movable latch, such as a first movable latch 328(1). The first movable latch 328(1) has an inner end 328a coupled to the actuator 330 such that movement of the actuator 330 along a first select direction D_{S1} causes movement of the first latch 328(1) along a second select direction D_{S2}. In this example, the first select direction D_{S1} is aligned with the first direction D₁ and the second select direction D_{S2} is aligned with the third direction D₃; however, alternative examples of the present disclosure are not so limited. The inner end 328a is configured to be inside the seat body 302. The first movable latch 328(1) has an outer end 328b configured to extend out from the first side 322 of the seat body 302 through an opening in the seat body 302. The outer end 328b defines a protrusion that extends out from the first side 322. The protrusion extends out further from the seat body 302 in the latched position than in the retracted position. In some embodiments, the protrusion is configured to be completely retracted into the seat body 302 in the retracted position such that no portion of the protrusion extends outside of the seat body 302. The first latch 328(1) is configured to engage the recess 214(2) of the seat bottom 200 to prevent the belt-positioning seat 300 from moving relative to the seat bottom 200 along at least one, up to all, of the first direction D₁, the second direction D₂, and the third direction D₃.

In some embodiments, the at least one movable latch includes a second movable latch 328(2). The second movable latch 328(2) has an inner end 328a coupled to the actuator 330 such that movement of the actuator 330 along the first select direction D_{S1} causes movement of the second latch 328(2) along the second select direction D_{S2}. The inner end 328a is configured to be disposed inside of the seat body 302. The second movable latch 328(2) has an outer end 328b configured to extend out from the second side 324 of the seat body 302 through an opening in the seat body 302. The outer end 328b defines a protrusion that extends out from the second side 322. The protrusion extends out further from the seat body 302 in the latched position than in the retracted position. In some embodiments, the protrusion is configured to be completely retracted into the seat body 302 in the retracted position such that no portion of the protrusion extends outside of the seat body 302. The first latch 328(1) is configured to engage the recess 214(2) of the seat bottom 200 to prevent the belt-positioning seat 300 from moving relative to the seat bottom 200 along at least one, up to all, of the first direction D₁, the second direction D₂, and the third direction D₃.

The actuator 330 includes an outer end 330a that defines an actuation surface 334 configured to be engaged by a user. The actuator 330 includes a handle 332 that defines the actuation surface 334. The actuation surface 334, and hence the handle 332, is configured to be exposed outside of the seat body 302 such that the actuation surface 334 is configured to be engaged by a user. In some embodiments, the actuation surface 334 is configured to be disposed at the front end 316 of the belt-positioning seat 300, and is configured to be exposed along the second seating surface 306. The actuation surface 334 is movable along the first select direction D_{S1} to move the at least one movable latch 328(1), 328(2) between the latched and unlatched positions. The actuator 330 includes an inner end 330b disposed within the seat body 302. The inner end 330b is configured to be coupled to the at least one movable latch 328(1), 328(2) such that movement of the actuator 330 along the first select direction D_{S1} causes movement of the at least one latch 328(1), 328(2) along the second select direction D_{S2}.

In some embodiments, the actuator 330 is configured to be movably coupled to the at least one latch 328 using a suitable mechanism that converts movement of the actuator 330 along the first select direction D_{S1} to movement of the at least one latch 328(1), 328(2) along the second select direction D_{S2}. In some embodiments, the inner end 330b of the actuator 330 has one of a protrusion or a ramped surface, and the at least one latch 328(1), 328(2) has another of the protrusion or the ramped surface. The ramped surface is configured to be angled relative to the first select direction D_{S1}. In some embodiments, the ramped surface extends inward as the ramped surface extends along a direction that extends from the outer end 330a of the actuator 330 to the inner end 330b of the actuator 330. Movement of the actuator 330 is configured to cause the protrusion to be guided along the ramped surface to cause the at least one latch 328(1), 328(2) to move along the second select direction D_{S2}.

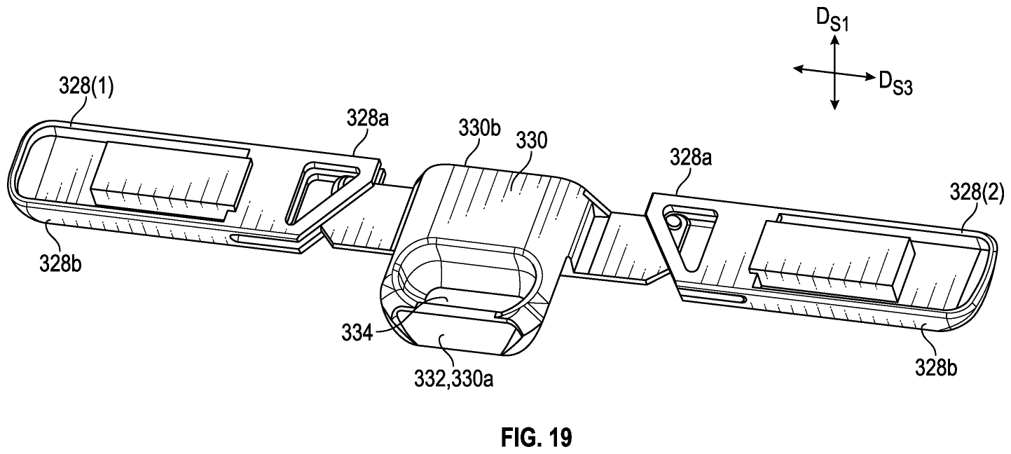

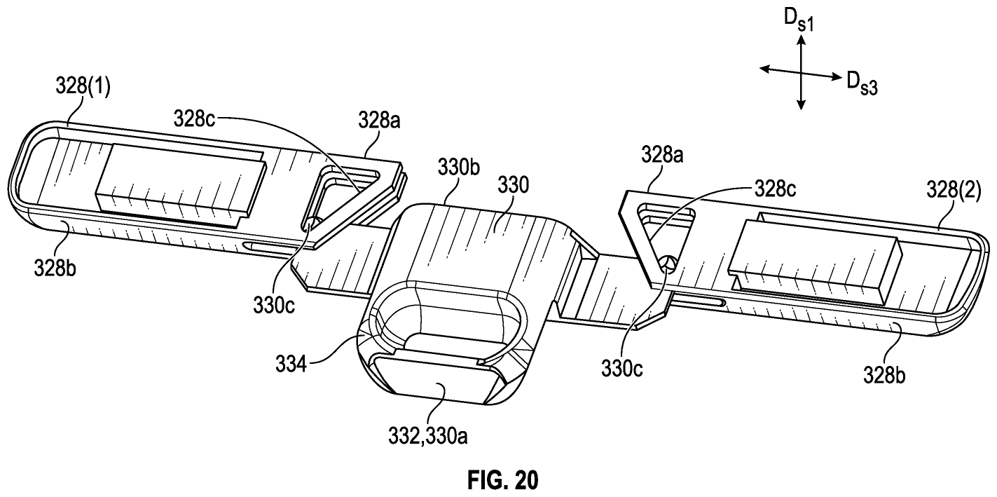

FIGS. 19 and 20 show some embodiments in which the inner end 330b of the actuator 330 includes, for each of the at least one latch 328(1), 328(2), a protrusion 330c, and each of the at least one latch 328(1), 328(2) includes a ramped surface 328c. In particular, the inner end 330b of the actuator 330 includes first and second protrusions 330c that are offset from one another along the second select direction D_{S2}. The inner end 328a of the first latch 328(1) has a ramped surface 328c that receives a first one of the protrusions 330c, and the inner end 328a of the second latch 328(2) has a ramped surface 328c that receives a second one of the protrusions 330c. Movement of the actuator 330 back and forth along the first select direction D_{S1} causes the first and second latches 328(1) and 328(2) to move towards and away from one another along the second select direction D_{S2} between the latched and unlatched positions. In some embodiments, the belt-positioning seat 300 includes at least one spring (not shown) configured to bias the at least one latch 328(1), 328(2) towards the latched position.

Referring generally to FIGS. 1, 15, and 16, in some embodiments, the seat body 302 of the belt-positioning seat 300 is configured to interface with the harness 400. For example, the seat body 302 of the belt-positioning seat 300 is configured to be removably coupled to the seat bottom 200 of the main seat 12 in the receiving space 204 such that, when the seat body 302 is positioned in the receiving space 204, the crotch buckle 406 is positioned above the second seating surface 306 to removably fasten to the first and second straps 402 and 404 of the harness 400. The belt-positioning seat 300 includes at least one crotch strap opening 336 that extends into the second seating surface 306 and configured to couple the crotch buckle 406 to the belt-positioning seat 300. The crotch strap opening 336 extends entirely through the seat body 302.

The webbing 410 of the crotch strap 408 extends through the crotch strap opening 336 such that the belt-positioning seat 300 is positioned between the seat bottom 200 and the crotch buckle 406. In some embodiments, the webbing 410 is attached to the seat bottom 200 and the crotch strap opening 336 is sized to receive the crotch buckle 406 therethrough as the belt-positioning seat 300 is received in the receiving space 204 of the seat bottom 200. In these embodiments, the child safety seat 10 is configured such that, when the belt-positioning seat 300 is removed from the main seat 12, the crotch buckle 406 remains attached to the seat bottom 200. Thus, an inner end of the webbing 410 is configured to be constrained by the seat bottom 200 against removal from the seat bottom 200. In some other embodiments, the webbing 410 is attached to the belt-positioning seat 300, and not the seat bottom 200, such that removal of the belt-positioning seat 300 from the child safety seat 10 causes the crotch buckle 406 to be removed along with the belt-positioning set 300 from the main seat 12. Thus, an inner end of the webbing 410 is configured to be constrained by the belt-positioning seat 300 against removal from the belt-positioning seat 300. In some embodiments, the belt-positioning seat 300 is configured such that, when the at least one belt guide 304 is stowed in the storage position, the at least one belt guide 304 does not obstruct the crotch strap opening 336 to prevent insertion or removal of the crotch buckle 406 through the crotch strap opening 336.

The belt-positioning seat 300 includes at least one lap belt opening configured to receive at least one of the first and second straps 402 and 404 of the harness 400. In some embodiments, the belt-positioning seat 300 includes a first lap belt opening 338(1) configured to receive a portion of the first strap 402 therethrough. Additionally, or alternatively, in some embodiments, the belt-positioning seat 300 includes a second lap belt opening 338(2) configured to receive a portion of the second strap 402 therethrough. In some embodiments, each lap belt opening is configured to be open at the rear end 314 or at one of the sides 322 and 324 of the belt-positioning seat 300 so as to facilitate installation of a respective one of the first and second straps 402 and 404 into the lap belt opening, and removal of the respective one of the first and second straps 402 and 404 from the lap belt opening.

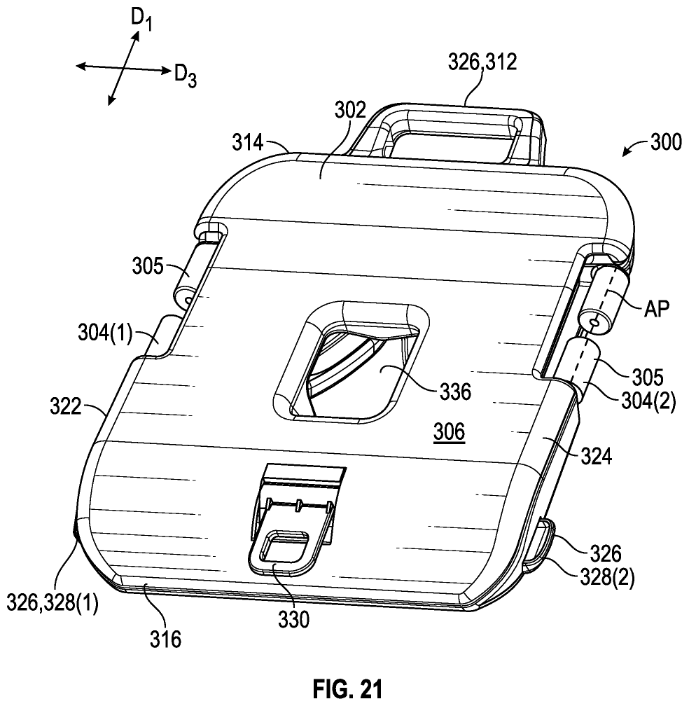

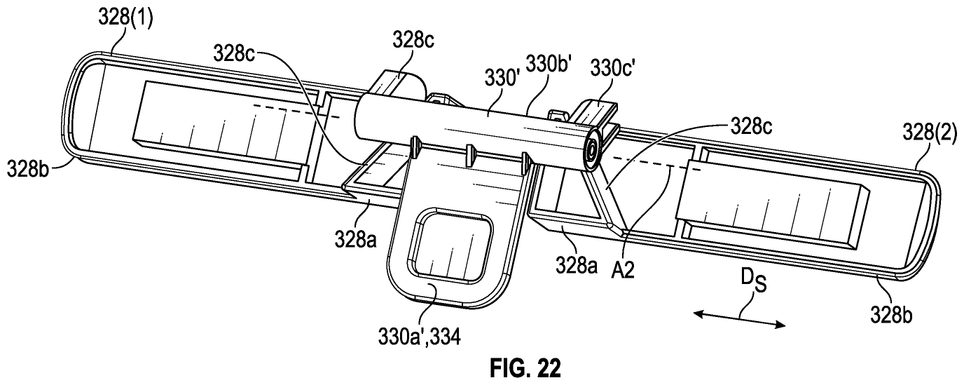

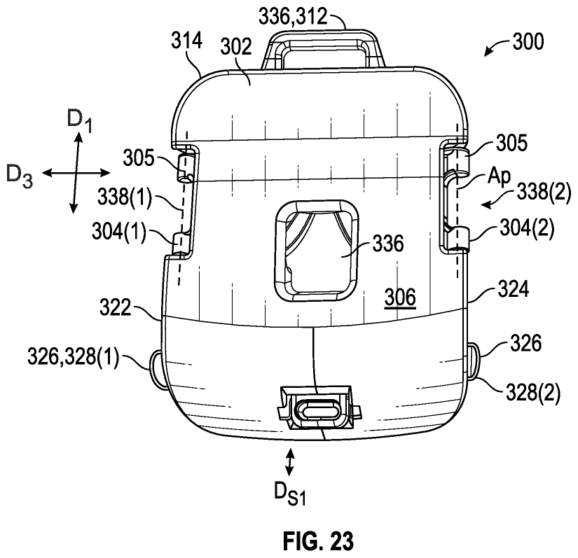

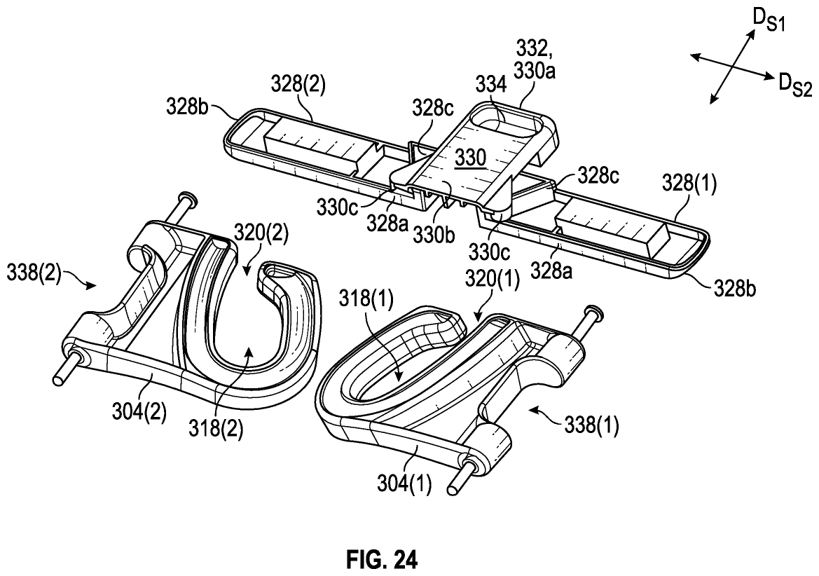

Referring to FIGS. 21 and 22, a belt-positioning seat 300′ is shown according to some embodiments. The belt-positioning seat 300′ is similar to the belt-positioning seat 300 of FIGS. 15 to 18, with a few notable exceptions. The features of the belt-positioning seat 300′ that differ from those of the belt-positioning seat 300 will now be described. All other features of the belt-positioning seat 300′ may be understood with reference to the description of those features above in relation to the belt-positioning seat 300. In some embodiments, the belt-positioning seat 300′ is configured to be devoid of the first and second lap belt openings 338(1) and 338(2). Instead, the belt-positioning seat 300′ is configured such that the first and second straps 402 and 404 route up the first and second sides 322 and 324 of the belt-positioning seat 300′ between the belt-positioning seat 300′ and the sidewalls 210(1) and 210(2) of the main seat 12. In some embodiments, the first and second straps 402 and 404 are configured to be routed through lap belt openings as will be discussed further below in relation to FIGS. 23 and 24.

The belt-positioning seat 300′ includes a rotatable actuator 330′, rather than the translatable actuator of the belt-positioning seat 300. Like the belt-positioning seat 300, the belt-positioning seat 300′ includes at least one movable latch, such as a first movable latch 328(1), and optionally, a second movable latch 328(2). Each movable latch 328(1), 328(2) has an inner end 328a coupled to the actuator 330′ such that rotation of the actuator 330′ about an axis of rotation A_{L} causes movement of the latch 328(1), 328(2) along a select direction D_{S}. In this embodiment, the select direction D_{S} is aligned with the third direction D₃, and the axis of rotation A_{L} is aligned with the select direction D_{S}. However, alternative embodiments are not so limited. The inner end 328a is configured to be disposed inside of the seat body 302. Each movable latch 328(1), 328(2) has an outer end 328b configured to extend out from the first side 322 of the seat body 302 through an opening in the seat body 302. The outer end 328b includes a protrusion that extends out from the first side 322. The protrusion extends out further from the seat body 302 in the latched position than in the retracted position. In some embodiments, the protrusion is configured to be completely retracted into the seat body 302 in the retracted position such that no portion of the protrusion extends outside of the seat body 302. Each latch 328(1), 328(2) is configured to engage a recess 214(2), 214(3) of the seat bottom 200 so as to prevent the belt-positioning seat 300 from moving relative to the seat bottom 200 along at least one, up to all, of the first direction D₁, the second direction D₂, and the third direction D₃.

The actuator 330′ includes an outer end 330a′ that defines an actuation surface 334 configured to be engaged by a user. The actuation surface 334 is configured to be exposed outside of the seat body 302 such that the actuation surface 334 is configured to be engaged by a user. In some embodiments, the actuation surface 334 is disposed at the front end 316 of the belt-positioning seat 300, and is exposed along the second seating surface 306. The actuation surface 334 is movable about the axis of rotation A_{L} so as to move the at least one movable latch 328(1), 328(2) between the latched and unlatched positions. The actuator 330′ includes an inner end 330b′ disposed within the seat body 302. The inner end 330b′ is configured to be coupled to the at least one movable latch 328(1), 328(2) such that rotation of the actuator 330′ causes movement of the at least one latch 328(1), 328(2) along the select direction D_{S}.

The inner end 330b′ of the actuator 330′ has a protrusion 330c′ for each of the at least one latch 328(1), 328(2), and each of the at least one latch 328(1), 328(2) includes a ramped surface 328c. In some embodiments, the inner end 330b′ of the actuator 330′ includes first and second protrusions 330c′ that are offset from one another along the select direction D_{S}. The inner end 328a of the first latch 328(1) has a ramped surface 328c that receives a first one of the protrusions 330c′, and the inner end 328a of the second latch 328(2) has a ramped surface 328c that receives a second one of the protrusions 330c′. Rotational movement of the actuator 330′ causes the first and second latches 328(1) and 328(2) to move towards and away from one another along the select direction D_{S} between the latched and unlatched positions. In at least some embodiments, the belt-positioning seat 300 includes at least one biasing member (not shown), such as a spring or resilient material, configured to bias the at least one latch 328(1), 328(2) towards the latched position.

Turning now to FIGS. 23 and 24, a belt-positioning seat 300″ is shown according to some embodiments. The belt-positioning seat 300″ is similar to the belt-positioning seat 300 of FIGS. 15 to 18, with a few notable exceptions. The features of the belt-positioning seat 300″ that differ from those of the belt-positioning seat 300 will now be described. All other features of the belt-positioning seat 300″ may be understood with reference to the description of those features above in relation to the belt-positioning seat 300.

Like the belt-positioning seat 300, the belt-positioning seat 300″ includes a first lap belt opening 338(1) configured to receive a portion of the first strap 402 therethrough, and/or a second lap belt opening 338(2) configured to receive a portion of the second strap 402 therethrough. However, rather than extending into the rear end 314 of the belt-positioning seat 300″, the first lap belt opening 338(1) extends into the first side 322 of the belt-positioning seat 300″, and the second lap belt opening 338(2) extends into the second side 324 of the belt-positioning seat 300″. In some embodiments, as shown, the first lap belt opening 338(1) extends into the first belt guide 304(1), such as into a lower end or the hinge 305 of the first belt guide 304(1). Additionally, or alternatively, in some embodiments, the first lap belt opening 338(1) extends into the seat body 302 at the first side 322. Similarly, the second lap belt opening 338(2) extends into the second belt guide 304(2), such as into a lower end or the hinge 305 of the second belt guide 304(2). Additionally, or alternatively, in some embodiments, the second lap belt opening 338(2) extends into the seat body 302 at the second side 324.

### Object Holders

Conventional booster and convertible child seats often includes one or more object holders, such as one or more cup holders. Each object holder often extends beyond an outer perimeter of the seat. For example, each object holder commonly projects outwardly from a side of the seat and/or from the front of the seat. Accordingly, the box or other packaging that houses the seat during shipping defines an envelope sufficiently large to accommodate the object holder(s). In order to limit the size of the packaging, various child seats in some embodiments of the present disclosure are configured such that the object holder(s) is configured to be transitioned between a stowed position in which the object holder(s) does not extend beyond the perimeter of the seat, and a use position in which the object holder(s) are positioned for use by a child seated in the child seat. The object holder(s) is configured to be implemented in any child safety seat, including any of the child safety seats described herein and child safety seats that are not described herein.

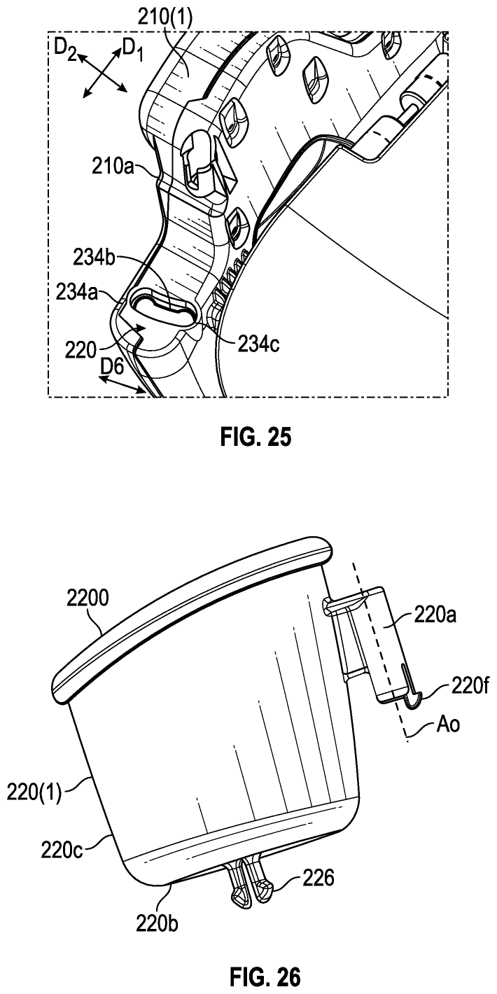

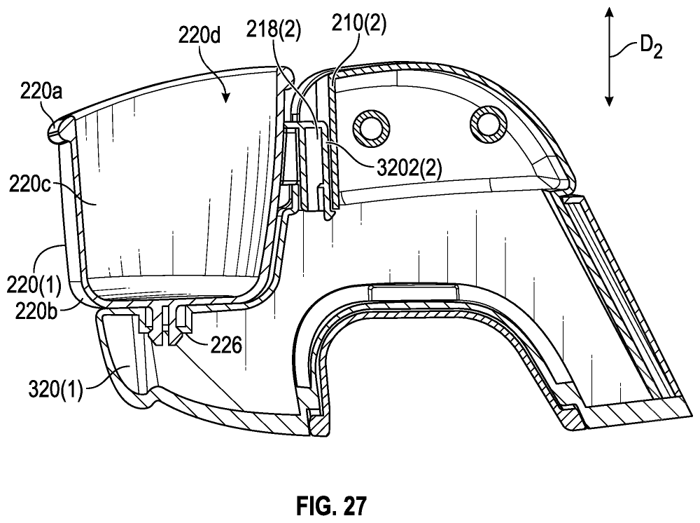

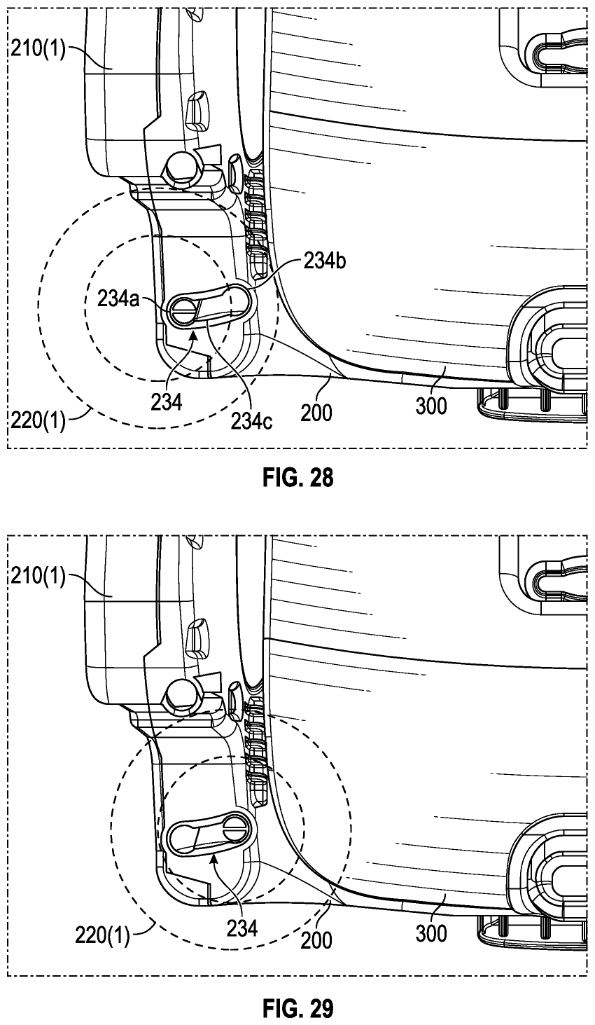

As described above in relation to FIGS. 6A and 6B, a child safety seat 10 in some embodiments includes at least one object holder, such as a pair of object holders 220(1) and 220(2). In some embodiments, at least one of the object holders 220(1) and 220(2) is a cupholder. In some embodiments, at least one of the object holders 220(1) and 220(2) is an object holder other than a cupholder, such as a snack holder. Each object holder 220(1) and 220(2) is configured to be disposed forward of a corresponding one of the sidewalls 210(1) and 210(2). Turning to FIGS. 25 to 29, in some embodiments, the at least one object holder 220(1), 220(2) is configured to be coupled to the seat bottom 200 such that the at least one object holder 220(1), 220(2) is rotatable relative to the seat bottom 200 between an extended position (e.g., FIG. 28) and a stowed position (e.g., FIG. 29), wherein the at least one object holder 220(1), 220(2) extends further out from the seat bottom 200 along the third direction D₃, when the object holder 220(1), 220(2) is in the extended position than when the object holder 220(1), 220(2) is in the stowed position. In some embodiments, the at least one object holder 220(1), 220(2) extends outwardly from a corresponding one of the sidewalls 210(1), 210(2) along the third direction D₃ when in the extended position, and is configured to be retracted relative to the sidewall 210(1), 210(2) along the third direction D₃ when in the stowed position.

Each object holder 220(1) and 220(2) has an upper end 220a and a lower end 220b that are spaced from one another along the second direction D₂. The lower end 220b is configured to be closed, and the upper end 220a is configured to be open to receive objects therein. Each object holder 220(1) and 220(2) has a recess 220d that extends into the upper end 220a and terminates at the lower end 220b. Each object holder 220(1) and 220(2) has at least one sidewall 220c that extends between the upper and lower ends 220a and 220b to define a closed shape about the recess 220d. Each object holder 220(1) and 220(2) has the closed shape when in each of the extended and stowed positions. An entirety of each object holder is configured to rotate between the extended and stowed positions.

The child safety seat 1 includes a coupler for each object holder 220(1) and 220(2) that rotatably couples the object holder to the seat bottom 200 such that the object holder rotates relative to the seat bottom 200 at a pivot axis A_{O} between the extended and stowed positions. In some embodiments, each object holder 220(1) and 220(2) includes at least one of a protrusion 220e and an opening configured to engage another of a protrusion and an opening 210a of the seat bottom 200 so as to rotatably couple the object holder to the seat bottom 200. The other of the protrusion and the opening 210a is configured to be implemented at the front end of the seat bottom 200, such as at a front end of a corresponding one of the sidewalls 210(1) and 210(2). In some embodiments, as shown, each object holder 220(1) and 220(2) includes a protrusion 220e shaped as a shaft 220e received in an opening 210a of the corresponding one of the sidewalls 210(1) and 210(2). In some other embodiments (not shown), each object holder 220(1) and 220(2) includes an opening that receives a shaft of a corresponding one of the sidewalls 210(1) and 210(2). The object holder 220(1) and 220(2) is configured pivot about the pivot axis A_{O}, which can be defined by the protrusion and/or the opening. In some embodiments, the pivot axis A_{O} extends upwards, such as along or at an angle to the second direction D₂.

The child safety seat 1 includes a fastener 220f for each object holder 220(1), 220(2) configured to affix the object holder 220(1), 220(2) to the seat bottom 200 so as to limit removal of the object holder 220(1), 220(2) along at least one, such as all, of the first, second, and third directions D₁, D₂, and D₃. Each fastener 220f is configured to limit removal of a corresponding object holder 220(1), 220(2) along the pivot axis A_{O}. In some embodiments, each fastener 220f has a spring finger. Each spring finger is configured to be pivotably coupled to an object holder 220(1), 220(2) or the seat bottom 200 and is configured to engage another of the object holder 220(1), 220(2) or the seat bottom 200 so as to limit removal of the object holder 220(1), 220(2) from the seat bottom 200. However, each fastener 220f is configured to be implemented as any other suitable fastener.

The child safety seat 1 includes a guide 234 for each object holder 220(1), 220(2) configured to guide movement of the object holder 220(1), 220(2) between the extended and stowed positions. Each guide 234 is configured to be included by an object holder 220(1), 220(2) or the seat bottom 200. The other of the object holder 220(1), 220(2) and the seat bottom 200 is configured to include a follower 236 configured to ride along the guide 234. FIGS. 25 to 28 show an embodiment in which each guide 234 is included in the seat bottom 200 at a location below a corresponding object holder 220(1), 220(2), and each object holder 220(1), 220(2) includes a follower 236 configured to ride along the guide 234. In this embodiment, each guide 234 includes an internal track, such as a slot, and each follower 236 includes a protrusion received in and rides along the internal track. The protrusion of the follower 236 includes a pair of opposing spring fingers. In some other embodiments, each guide includes an external track, such as a T-track, and the follower includes a recess that receives the external track. Further, in some other embodiments, each guide is configured to be implemented by an object holder and each follower is configured to be implemented by the seat bottom 200.

In some embodiments, each guide 234 is configured to selectively lock one of the object holders 220(1), 220(2) in the extended and stowed positions. The guide 234 has a first enlarged portion 234a that corresponds to the extended position, a second enlarged portion 234b that corresponds to the stowed position, and an intermediate portion 234c between the first and second enlarged portions 234a and 234b. The first and second enlarged portions 234a and 234b are spaced from one another along a direction DG, and the intermediate portion 234c includes a width along a direction perpendicular to the direction DG, less than a width of the first and second enlarged portions 234a and 234b along the direction DG. The follower 236 is configured to snap into the first and second enlarged portions 234a and 234b when moved to the extended and stowed positions, respectively. Although not shown, in some embodiments, each guide 234 has at least one intermediate position between the extended and stowed positions. For example, each guide 234 has at least one enlarged portion between the first and second enlarged portions 234a and 234b that corresponds to the at least one intermediate position.

Each object holder 220(1), 220(2) is configured to be positioned in the extended position when used by a child. When in the extended position, the child can have more leg room, as the object holder 220(1), 220(2) protrudes further into the seating area when the object holder 220(1), 220(2) is in the stowed position than in the extended position. Each object holder 220(1), 220(2) is configured to be positioned in the stowed position to reduce the outer width of the child safety seat 1 along the third direction D₃. This configuration is beneficial to limit the size of packaging, such as the size of a box, needed to store the child safety seat 1 for shipping. This configuration is also beneficial when more room is desired to position one or more child safety seats next to the child safety seat 1 in a seating row of a vehicle.

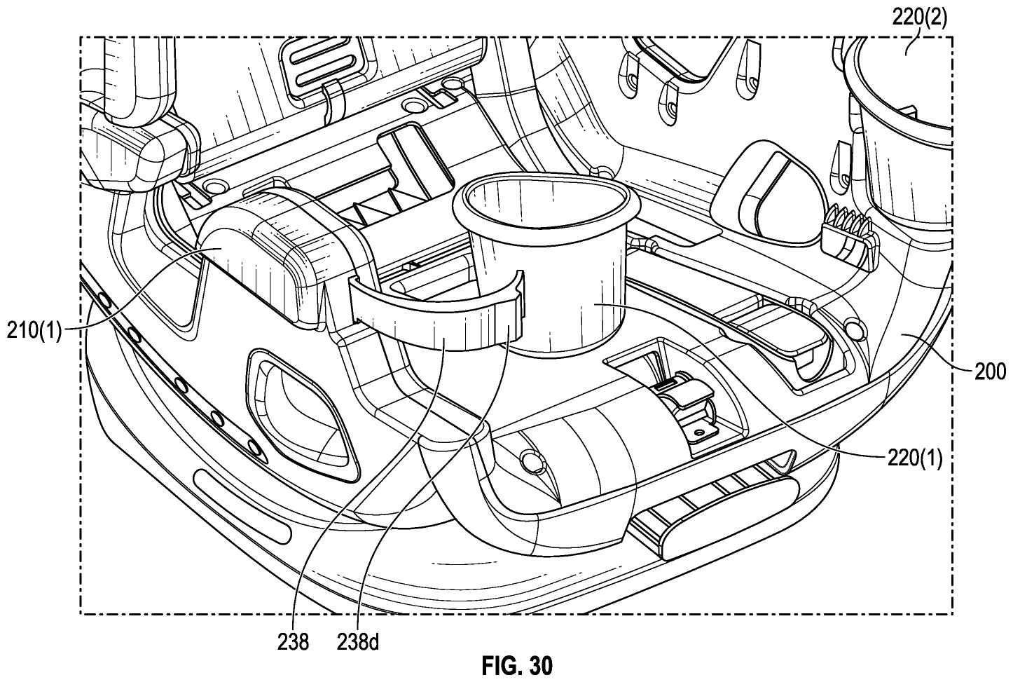

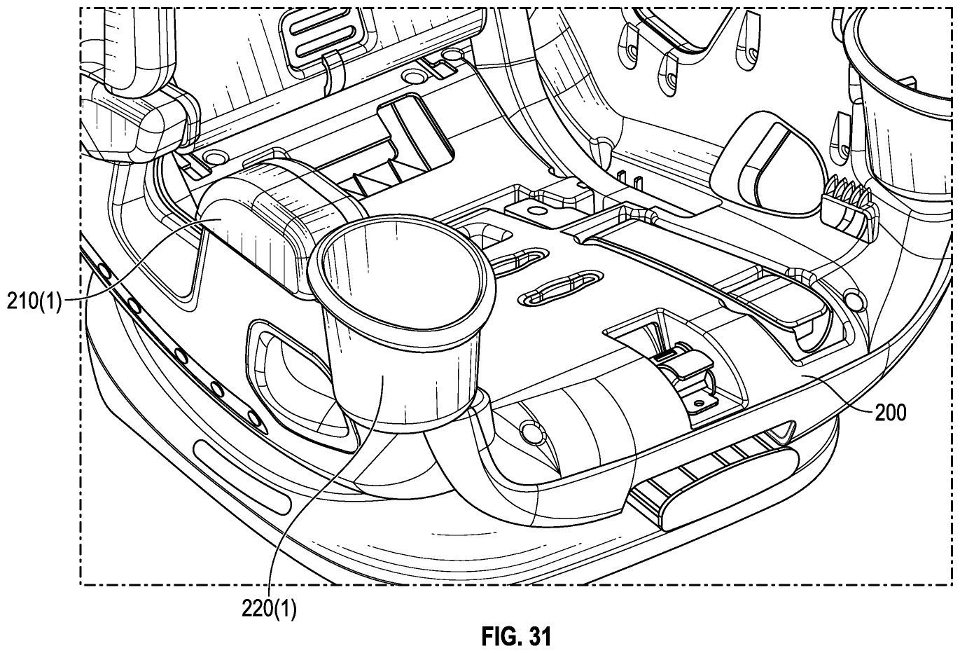

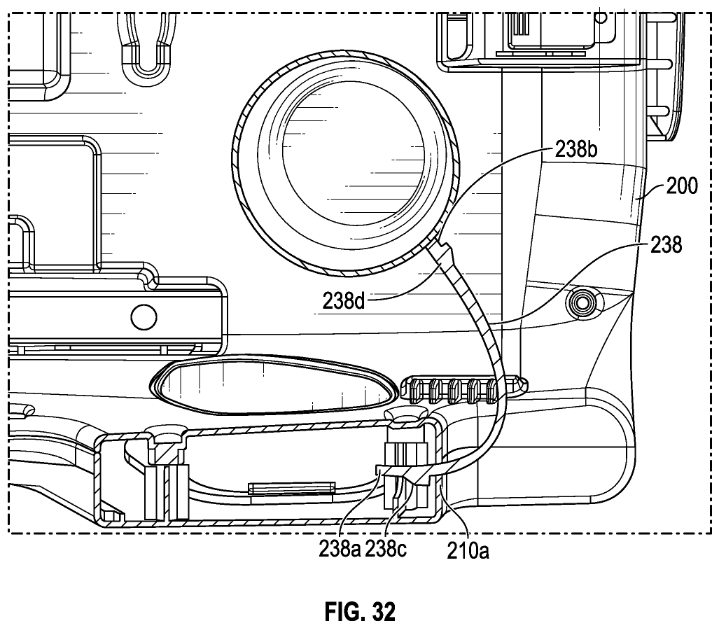

Turning now to FIGS. 30 to 32, in some embodiments, each object holder 220(1), 220(2) is configured to be attached to the seat bottom 200 using a tether 238. Each object holder 220(1), 220(2) is configured to be transitioned between an unfixed position (e.g., FIGS. 30 and 32) and a use position (e.g., FIG. 31). In the unfixed position, the object holder 220(1), 220(2) is movable relative to the seat bottom 200, where motion of the object holder 220(1), 220(2) is constrained by the tether 238. In the use position, the object holder 220(1), 220(2) is positioned to be used by a child seated in the child safety seat 1. In some embodiments, in the use position, the object holder 220(1), 220(2) is configured to be positionally fixed relative to the seat bottom 200 such that movement of the seat bottom 200 causes a corresponding movement of the object holder 220(1), 220(2). In some embodiments, each object holder 220(1), 220(2) is configured to be positionally fixed to a corresponding sidewall 210(1), 210(2).

Each tether 238 is a wire, string, plastic strip, or any other suitable tether. Each tether 238 has a first end 238a attached to the seat bottom 200, such as to one of the sidewalls 210(1), 210(2). Each tether 238 has a second end 238b attached to a corresponding object holder 220(1), 220(2). Each first end 238a is configured to be attached to one of the sidewalls 210(1), 210(2), such as to a front end of one of the sidewalls 210(1), 210(2). Each tether 238 is configured to be attached to the seat bottom 200 in any suitable manner. In some embodiments, the first end 238a of each tether 238 is configured to be received in an opening 210a in one of the sidewalls 210(1), 210(2), or otherwise attached thereto. The first end 238a of each tether 238 includes a tooth 238c configured to be received in the opening 210a of the seat bottom 200, and configured to create an interference with an inner surface of the seat bottom 200 to prevent the tooth 238c from being removed from the opening 210a. The tooth 238c is disposed closer to the first end 238a than the second end 238b.

The child safety seat 1 includes a fastener configured to affix the object holder 220(1), 220(2) to the seat bottom 200 in the use position. The fastener can be any suitable fastener. FIGS. 30 to 32 show some embodiments in which the fastener is a locking tooth 238d disposed at the second end 238b adjacent a corresponding object holder 220(1), 220(2). The locking tooth 238d is configured to be received in an opening 210a of the seat bottom 200, and configured to create an interference with an inner surface of the seat bottom 200 to prevent the locking tooth 238d from being removed from the opening 210a. To transition an object holder 220(1), 220(2) to the use position, a corresponding tether 238 is received in an opening 210a of the seat bottom 200 until the locking tooth 238d is received in the opening 210a. A wall of the seat bottom 200 is then trapped between the locking tooth 238d and the object holder 220(1), 220(2). A distance between the locking tooth 238d and the object holder 220(1), 220(2) is configured to be substantially equal to a thickness of a wall of the seat bottom 200 that defines the opening 210a.

Although various embodiments of a child safety seat that have been described include a removable belt-positioning seat 300 and at least one object holder 220(1), 220(2), embodiments of the present disclosure are not limited to including both the removable belt-positioning seat 300 and the at least one object holder 220(1), 220(2). In some embodiments, the child safety seat includes the removable belt-positioning seat 300 described herein, but not the at least one object holder 220(1), 220(2). In some other embodiments, the child safety seat includes the at least one object holder 220(1), 220(2), but not the removable belt-positioning seat 300.

It should be noted that the illustrations and descriptions of the examples and embodiments shown in the figures are for example purposes only, and should not be construed limiting the disclosure. One skilled in the art will appreciate that the present disclosure contemplates various embodiments. Additionally, it should be understood that the concepts described above with the above-described examples and embodiments may be employed alone or in combination with any of the other examples and embodiments described above. It should further be appreciated that the various alternative examples and embodiments described above with respect to one illustrated embodiment can apply to all examples and embodiments as described herein, unless otherwise indicated.

Unless explicitly stated otherwise, each numerical value and range should be interpreted as being approximate as if the word “about,” “approximately,” or “substantially” preceded the value or range. The terms “about,” “approximately,” and “substantially” can be understood as describing a range within 15 percent of a specified value unless otherwise stated.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain examples have been described, these examples are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

The words “inward,” “outward,” “upper,” and “lower” refer to directions toward or away from, respectively, the geometric center of the highchair and its components.

It will be understood that reference herein to “a” or “one” to describe a feature such as a component or step does not foreclose additional features or multiples of the feature. For instance, reference to a device having, comprising, including, or defining “one” of a feature does not preclude the device from having, comprising, including, or defining more than one of the feature, as long as the device has, comprises, includes, or defines at least one of the feature. Similarly, reference herein to “one of” a plurality of features does not foreclose the invention from including two or more of the features. For instance, reference to a device having, comprising, including, or defining “one of a protrusion and a recess” does not foreclose the device from having both the protrusion and the recess.

1. A child safety seat for a vehicle, comprising:
a main seat comprising a seatback, a seat bottom attached to the seatback, and a pair of belt guides, the seat bottom having a first seating surface that defines a receiving space between the pair of belt guides;
a harness including a first strap, a second strap, and a crotch buckle; and
a belt-positioning seat including a seat body and at least one belt-positioning guide, the seat body having a second seating surface, and a bottom surface configured to be placed on a vehicle seat, wherein:
the at least one belt-positioning guide protrudes upward from the second seating surface; and
the seat body is configured to be removably coupled to the seat bottom in the receiving space such that, when the seat body is positioned in the receiving space, the crotch buckle is positioned above the second seating surface to removably fasten to the first and second straps.

2. The child safety seat of claim 1, wherein the belt-positioning seat includes at least one opening that extends into the second seating surface and is configured to couple the crotch buckle to the belt-positioning seat.

3. The child safety seat of claim 2, wherein the harness comprises a crotch strap having the crotch buckle, and a webbing attached to the crotch buckle, and when the seat body is positioned in the receiving space, the webbing extends through the at least one opening.

4. The child safety seat of claim 3, wherein the webbing is attached to the seat bottom and the at least one opening is sized to receive the crotch buckle therethrough as the belt-positioning seat is received in the receiving space.

5. The child safety seat of claim 3, wherein the webbing is attached to the belt-positioning seat such that removal of the belt-positioning seat from the main seat causes the crotch buckle to be removed with the belt-positioning seat from the main seat.

6. The child safety seat of claim 2, wherein the belt-positioning seat is configured such that the at least one belt-positioning guide does not obstruct the at least one opening to prevent installation or removal of the crotch buckle through the at least one opening.

7. The child safety seat of claim 1, wherein the belt-positioning seat comprises at least one lap belt opening configured to receive a lap belt portion of a harness therethrough.

8. The child safety seat of claim 7, wherein the at least one lap belt opening comprises a pair of lap belt openings that are spaced from one another along a direction that extends from a first belt guide of the pair of belt guides to a second belt guide of the pair of belt guides.

9. The child safety seat of claim 8, wherein first and second belt openings of the pair of lap belt openings extend into first and second sides of the belt-positioning seat, respectively.

10. The child safety seat of claim 8, wherein the at least one belt-positioning guide comprises:
a first belt-positioning guide pivotably coupled to the seat body at a first side, inward of the first belt opening; and
a second belt-positioning guide pivotably coupled to the seat body at a second side, inward of the second belt opening.

11. The child safety seat of claim 8, wherein each lap belt opening extends into a rear end of the belt-positioning seat.

12. The child safety seat of claim 1, wherein the seat bottom comprises first and second sidewalls that are spaced from one another to define at least a portion of the receiving space therebetween.

13. The child safety seat of claim 12, wherein each of the first and second sidewalls defines at least one of a belt guide or an armrest.

14. The child safety seat of claim 13, wherein:
the seat bottom comprises a rear end attached to the seatback, and a front end spaced from the rear end along a first direction;
the armrest includes first and second armrests and the belt guide includes first and second belt guides; and
the first and second armrests are offset from the first and second belt guides, respectively, along the first direction.

15. The child safety seat of claim 1, further comprising:
a base attached to the seat such that the seat is configured to move relative to the base between an upright configuration and a reclined configuration; and
a lock configured to selectively fix the seat relative to the base in the upright and reclined configurations.

16. The child safety seat of claim 15, wherein the base has a curved surface that conforms to a curved surface of the seat, and the seat is configured to transition between the upright configuration and the reclined configuration by translating the curved surface of the seat along the curved surface of the base.

17. The child safety seat of claim 15, wherein the base comprises a foot configured to be placed on a vehicle seat and move to transition the child safety seat between the upright configuration and the reclined configuration.

18. The child safety seat of claim 1, wherein the at least one belt guide is configured to be transitioned between a deployed position in which the at least one belt guide protrudes upward from the second seating surface, and a storage position in which the at least one belt guide is stowed in a storage cavity defined in the seat body.

19. The child safety seat of claim 1, wherein the seat bottom and the belt-positioning seat are both configured to decouple from the seatback.

20. The child safety seat of claim 1, wherein the belt-positioning seat occupies a volume smaller than that of the seat bottom.

21. A child safety seat, comprising:
a base;
a main seat supported by the base, the main seat comprising:
a seat bottom comprising a pair of belt guides that define a receiving space therebetween;
a seatback attached to the seat bottom, the seatback being configured to move relative to the base such that the seatback moves between an upright configuration and a reclined configuration;
a lock configured to selectively fix the main seat relative to the base in the upright and reclined configurations; and
a belt-positioning seat configured to be received in the receiving space to removably couple the belt-positioning seat to the main seat, the belt-positioning seat including a seat body and at least one belt guide of the pair of belt guides, the seat body having an upper seating surface, and a bottom surface adapted to be placed on a vehicle seat, and the at least one belt guide protruding upward from the seat body.

22. The child safety seat of claim 21, wherein the seat bottom comprises first and second belt guides that are spaced from one another to define at least a portion of the receiving space therebetween.

23. The child safety seat of claim 21, wherein the seat bottom comprises first and second armrests that are spaced from one another to define at least a portion of the receiving space therebetween.

24. The child safety seat of claim 23, wherein:
the seat bottom comprises a rear end attached to the seatback, and a front end spaced from the rear end along a first direction; and
the first and second armrests are offset from the first and second belt guides, respectively, along the first direction.

25. The child safety seat of claim 21, wherein the seat bottom comprises an upper surface that defines a recess therein, wherein the recess at least partially defines the receiving space, and the upper seating surface of the seat body defines a bottom surface of the recess.

26. The child safety seat of claim 21, wherein the base has a curved surface that conforms to a curved surface of the seat, and the seat is configured to transition between the upright configuration and the reclined configuration by translating the curved surface of the seat along the curved surface of the base.

27. The child safety seat of claim 21, wherein the base comprises a foot configured to be placed on a vehicle seat and move so as to transition the child safety seat between the upright configuration and the reclined configuration.

28. The child safety seat of claim 21, wherein the at least one belt guide is configured to be transitioned between a deployed position in which the at least one belt guide protrudes upward from the upper seating surface, and a storage position in which the at least one belt guide is stowed in a storage cavity defined in the seat body.

29. The child safety seat of claim 21, wherein the seat bottom and the belt-positioning seat are both configured to decouple from the seatback.

30. The child safety seat of claim 21, wherein the belt-positioning seat occupies a volume smaller than that of the seat bottom.
